(19) United States
(12) Patent Application Publication
(10) Pub. No.: US 2026/0238782 A1
(43) Pub. Date: Aug. 13, 2026

(54) Template Sample Selection for Illumination Compensation

(71) Applicant: Ofinno, LLC, Reston, VA (US)

(72) Inventors: Vasily Alexeevich Rufitskiy, Vladimir (RU); Alexey Konstantinovich Filippov, Khimki (RU); Esmael Hejazi Dinan, McLean, VA (US)

(73) Assignee: Ofinno, LLC, Reston, VA (US)

(21) Appl. No.: 19/639,358

(22) Filed: Apr. 6, 2026

Related U.S. Application Data
(63) Continuation of application No. PCT/US2024/050210, filed on Oct. 7, 2024.
(60) Provisional application No. 63/543,008, filed on Oct. 6, 2023.

(51) Int. Cl. H04N 19/117; H04N 19/176; H04N 19/503

(52) U.S. Cl. CPC H04N 19/117; H04N 19/176; H04N 19/503

(57) ABSTRACT

A coder determines, based on illumination compensation being enabled for a reference block (RB), whether a first portion and a second portion of a current template of a current block (CB) is available. The first and second portions include samples of the current template to the left of and above the CB, respectively. Based on the determination of whether the first and second portions are available, a sampling pattern is determined for the current template of the current block and for a reference template of the RB. Values of parameters of a filter are derived based on the sampling pattern, available template samples of at least one of the first and second portions, and reference template samples of the reference template. The coder applies the filter to the RB to generate a prediction block and the current block is decoded based on the prediction block.

### CROSS-REFERENCE TO RELATED APPLICATIONS

This application is a continuation of International Application No. PCT/US2024/050210, filed Oct. 7, 2024, which claims the benefit of U.S. Provisional Application No. 63/543,008, filed Oct. 6, 2023, all of which are hereby incorporated by reference in their entireties.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 show examples of binary tree and ternary tree partitions.

FIG. 7A shows an example of combined quadtree and multi-type tree partitioning of a CTB.

FIG. 7B shows an example tree corresponding to the combined quadtree and multi-type tree partitioning of the CTB shown in FIG. 7A.

FIG. 8 shows an example of partitioning modes in AV1.

FIG. 9 shows an example set of reference samples determined for intra prediction of a current block.

FIG. 10A, FIG. 10B, and FIG. 10C show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17A shows an example of a current block and a reference block with corresponding templates used in determining scale and offset parameters for local illumination compensation (LIC) during inter prediction, according to some embodiments.

FIG. 17B shows an example process for generating a predicted block when LIC is used during inter prediction, according to some embodiments.

FIG. 18A shows a process for generating a predicted block by applying an illumination compensation function (e.g., a filter model) that uses a multiple-tap filter to generate predicted samples from samples of the reference template, according to some embodiments.

FIG. 18B shows an example reference template and example multiple-tap filter models that may be applied to the reference template to generate a multi-tap filter, according to some embodiments.

FIG. 19 shows an example of subsampling (decimation) to select template samples for LIC parameter derivation, according to some embodiments.

FIG. 20 shows an example of subsampling (decimation) to select template samples for a first regular case for LIC parameter derivation, according to some embodiments.

FIG. 21 shows an example of subsampling (decimation) to select template samples for a second irregular case for LIC parameter derivation, according to some embodiments.

FIG. 22 shows an example of down-sampling or subsampling to select template samples for a first irregular case for LIC parameter derivation, according to some embodiments.

FIG. 23 shows an example of down-sampling or subsampling to select template samples for a second irregular case for LIC parameter derivation, according to some embodiments.

FIG. 24 shows an example of down-sampling or subsampling to select template samples within a split unit coding order (SUCO) partitioning framework when above, left, and right sides are available, according to some embodiments.

FIG. 25 shows an example of down-sampling or subsampling to select template samples within a SUCO partitioning framework when above and right sides are available, according to some embodiments.

FIG. 26 shows an example of down-sampling or subsampling to select template samples within a SUCO partitioning framework when an above side is available, according to some embodiments.

FIG. 27 shows a flowchart of a method for (e.g., by a decoder) determining, based on first available template samples of a current block (CB), a down-sampling pattern for the current template of the CB and a reference template of a reference block (RB), and deriving parameters of a filter based on the down-sampling pattern, the first available template samples, and second template samples of the reference template, according to some embodiments.

FIG. 28 shows a flowchart of a method for (e.g., by an encoder) determining, based on first available template samples of a current block (CB), a down-sampling pattern for the current template of the CB and a reference template of a reference block (RB), and deriving parameters of a filter based on the down-sampling pattern, the first available template samples, and second template samples of the reference template, according to some embodiments.

FIG. 29 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

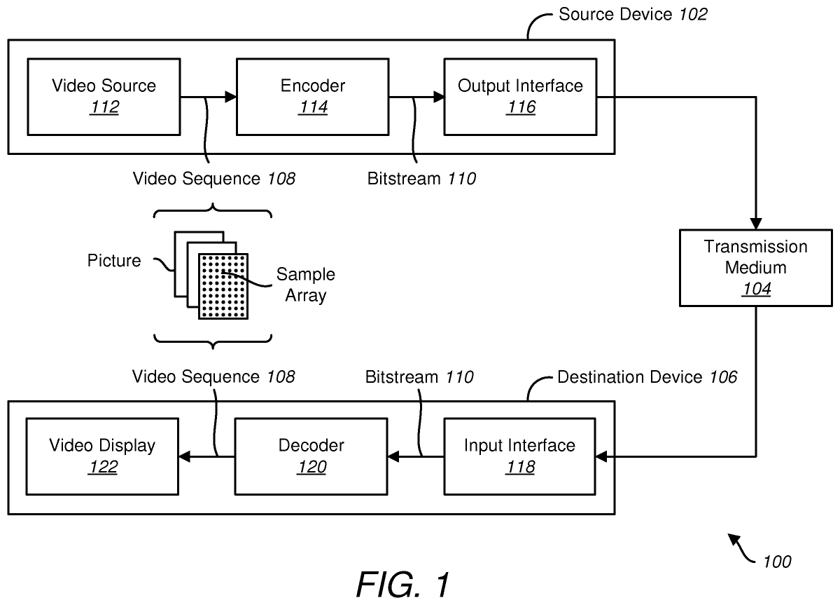

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g. using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein). Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and/or AOMedia Video 1 (AV1), and/or any other video coding protocol).

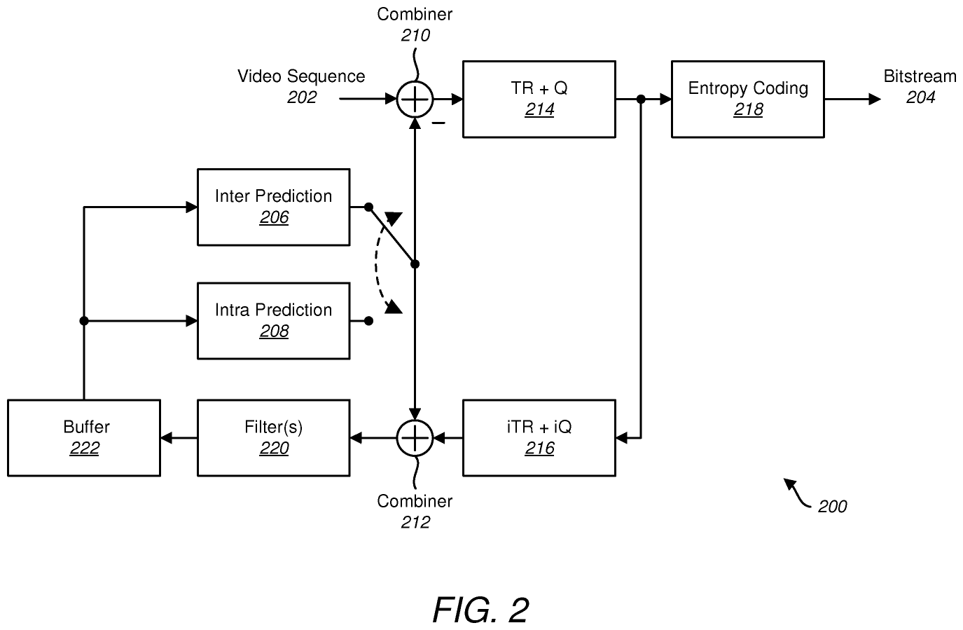

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter, a sample-adaptive offset (SAO) filter, constrained directional enhancement filters (CDEFs), and/or loop restoration (LR) filters. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video cording protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), syntax-based context-based binary arithmetic coding (SBAC), and/or symbol-to-symbol adaptive multi-symbol (non-binary) arithmetic coding to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

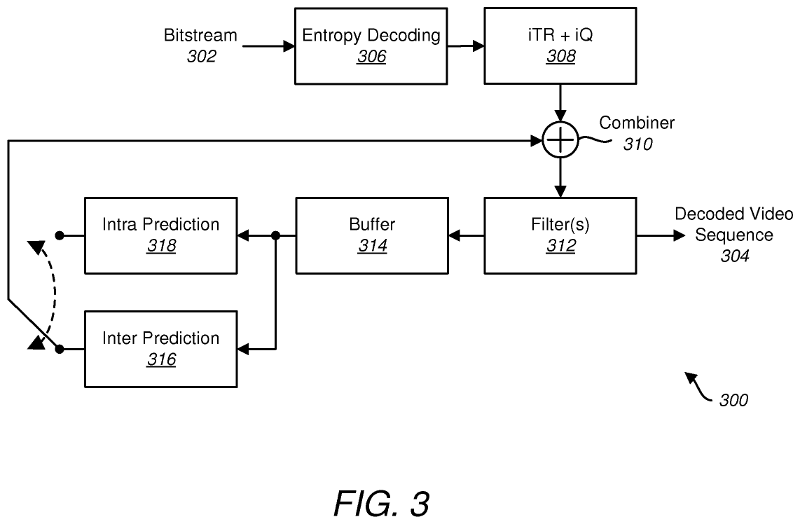

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter, a sample-adaptive offset (SAO) filter, constrained directional enhancement filters (CDEFs), and/or loop restoration (LR) filters. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. A CB may also be further partitioned into intra sub-partitions (ISP) where the reconstructed samples of each sub-partition are available to generate the prediction of the next sub-partition. For example, a CB may be split into 2 to 4 sub-partitions. For transformations, a CB may be partitioned into one or more transform blocks (TBs). A TB may be a rectangular block of samples that may determine/indicate an applied transform size.

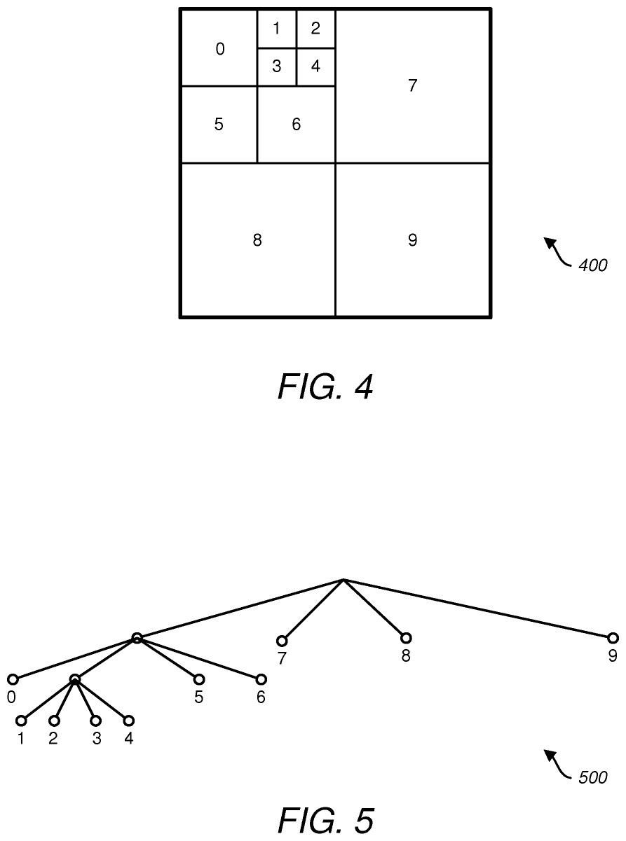

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

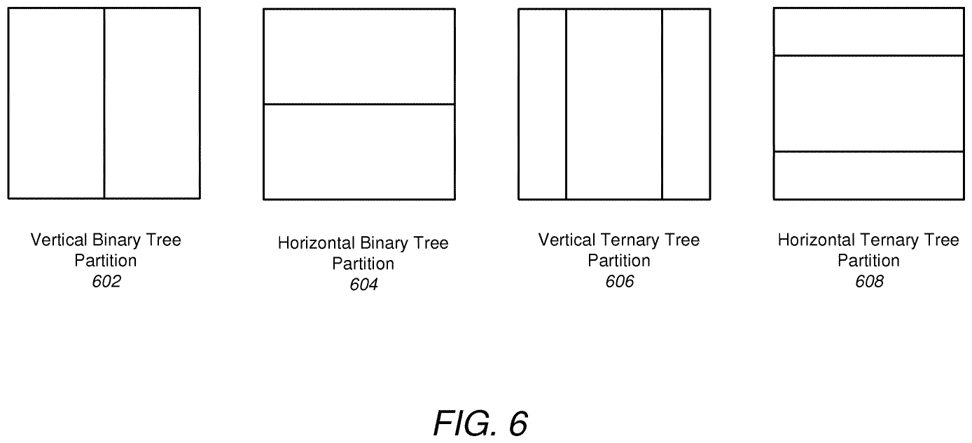

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

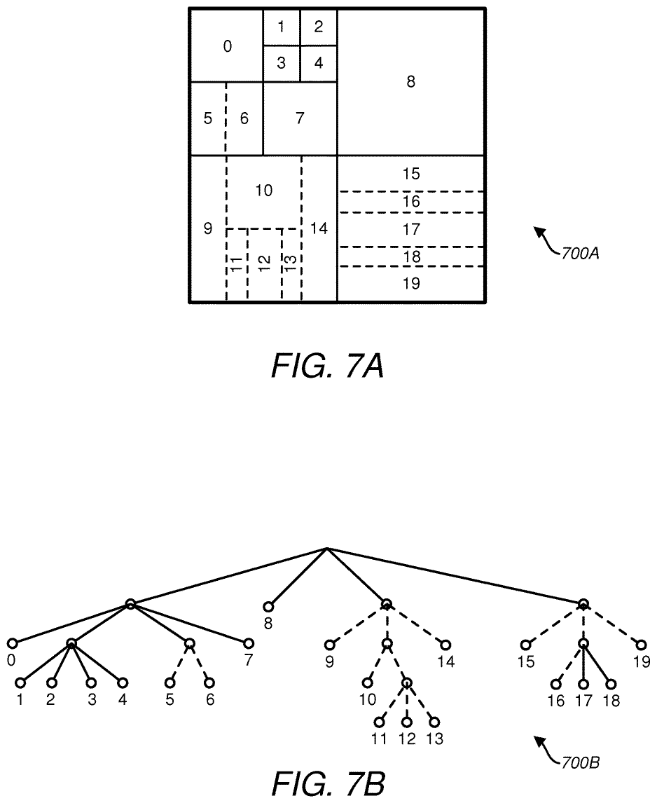

FIG. 7A shows an example of combined quadtree and multi-type tree partitioning of a CTB 700A. FIG. 7B shows an example tree 700B corresponding to the combined quadtree and multi-type tree partitioning of CTB 700A shown in FIG. 7A. In both FIGS. 7A and 7B, quadtree splits are shown in solid lines and multi-type tree splits are shown in dashed lines. For ease of explanation, CTB 700A is shown with the same quadtree partitioning as the CTB 400 described in FIG. 4, and a description of the quadtree partitioning of CTB 700A, which is similar to that for CTB 400, is omitted. The quadtree partitioning of the CTB 700A is merely an example and a CTB may be quadtree partitioned in a manner different from the CTB 700A. Additional multi-type tree partitions of CTB 700A may be made relative to three leaf CBs shown in FIG. 4. The three leaf CBs in FIG. 4 that are shown in FIG. 7A as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7A and 7B. The leaf CB 8 of FIG. 4 may be partitioned into three CBs based on a vertical ternary tree partition. Two of the three resulting CBs may be leaf CBs respectively labeled 9 and 14 in FIGS. 7A and 7B. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7A and 7B. The leaf CB 9 of FIG. 4 may be partitioned into three CBs based on a horizontal ternary tree partition. Two of the three CBs may be leaf CBs respectively labeled 15 and 19 in FIGS. 7A and 7B. The remaining, non-leaf CB may be partitioned into three CBs based on another horizontal ternary tree partition. The resulting three CBs may all be leaf CBs respectively labeled 16, 17, and 18 in FIGS. 7A and 7B.

Altogether, CTB 700A may be partitioned into 20 leaf CBs respectively labeled 0-19. The 20 leaf CBs may correspond to 20 leaf nodes (e.g., 20 leaf nodes of tree 700B shown in FIG. 7B). The resulting combination of quadtree and multi-type tree partitioning of the CTB 700A may be scanned using a z-scan (left-to-right, top-to-bottom) to form the sequence order for encoding/decoding the CB leaf nodes. A numeric label of each CB leaf node in FIGS. 7A and 7B may correspond to the sequence order for encoding/decoding, with CB leaf node 0 encoded/decoded first and CB leaf node 19 encoded/decoded last. Although not shown in FIGS. 7A and 7B, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

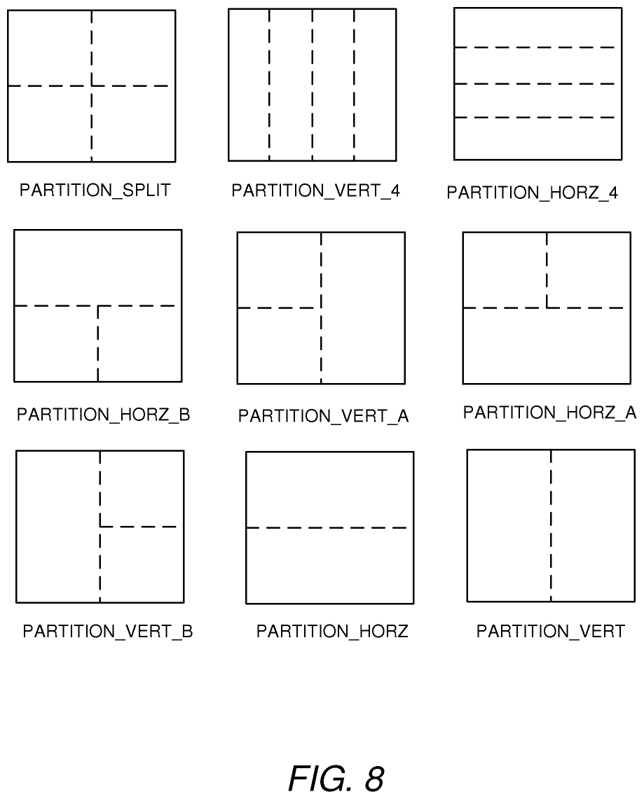

In some implementations of partitioning (e.g., AV1), a picture can be partitioned into multiple coding blocks. The largest coding blocks are also referred to as superblocks having sizes of either 128×128 or 64×64. Superblocks can be partitioned into smaller coding blocks which can be performed in nine partitioning modes. FIG. 8 shows the nine partitioning modes among which only PARTITION_SPLIT allows recursive partitioning. In addition, PARTITION_VERT_4 and PARTITION_HORZ_4 modes are not allowed for 8×8 or 128×128 coding blocks, and T-shaped partitioning modes are not allowed for 8×8 coding blocks. The minimum coding block size is 4×4. Intra and inter coding blocks can be further partitioned into transform blocks and the partitioning depth is up to two levels.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block (coding block or transform block) in the AV1 coding format.

In intra prediction, samples of a block to be encoded (e.g., also referred to as a current block) may be predicted from samples in a line of samples immediately adjacent to the current block. For example, the line of samples may include samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

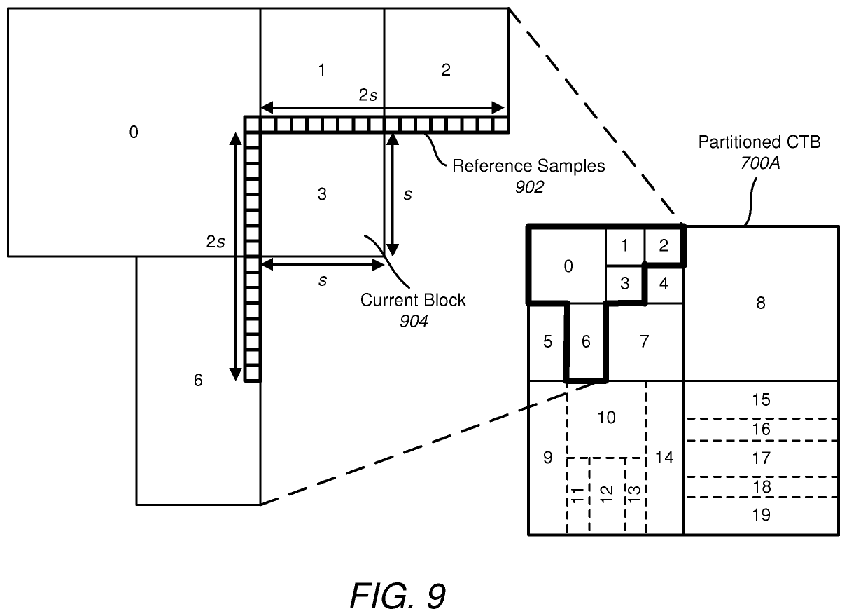

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7A. As described herein, the numeric labels 0-19 of the blocks of partitioned CTB 700A may correspond to the sequence order for encoding/decoding the blocks and may be used as such in the example of FIG. 9.

In some embodiments, reference samples 902 may include a line of samples immediately adjacent to current block 904 and include samples from a column and a row immediately adjacent to current block 904. For example, the line of samples may include reference samples to the left and/or above current block 904. In some embodiments, reference samples 902 may be obtained (or selected) from a reference line of multiple reference lines (MRL), which may include a line of samples adjacent to current block 904 and also a line of non-adjacent samples. The MRL may include reference lines identified by corresponding reference line indices that indicate an i-th line of samples adjacent to current block 904 such that the 0-th line indicates the reference line immediate adjacent (or closest) to current block 904 and a higher numbered i-th line indicates a line of samples further away from current block 904. An encoder may select a reference line from a set of MRL and signal an MLR index in the bitstream to indicate the selected reference line. For example, the encoder may signal a codeword encoding the MRL index. The decoder may decode the codeword to determine the MRL index that identifies a specific reference line used in intra prediction of current block 904.

For current block 904 that is w×h samples in size, reference samples 902 may comprise: 2w samples (or any other quantity of samples) of an i-th row (e.g., indicated by an MRL index) adjacent to the top-most row of current block 904, 2h samples (or any other quantity of samples) of the i-th column adjacent to the left-most column of current block 904, and the top left neighboring corner sample(s) extending from the i-th column and i-th row with respect to current block 904. Current block 904 may be square, such that w=h=s. In other examples, a current block need not be square, such that w #h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, 2, and 8 may be available to construct reference samples 902 given that these blocks are encoded and reconstructed at an encoder and decoded at a decoder prior to coding of current block 904. The samples from neighboring blocks 0, 1, 2, and 8 may be available to construct reference samples 902, for example, if there are no other issues (e.g., as mentioned above) preventing the availability of the samples from the neighboring blocks 0, 1, 2, and 8. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

Samples of current block 904 may be intra predicted based on reference samples 902, for example, based on (e.g., after) determination and (optionally) filtering of reference samples 902. In some examples, a filtering scheme (e.g., a filtering algorithm) may be applied to reference samples 902 to improve prediction accuracy. The filtering scheme may be one of a plurality of filter types including at least: a smoothing filter (or reference sample smoothing filter) or an interpolation filter. In some examples, if reference samples of a given block are to be filtered, only one of the plurality of filter types is selected (e.g., activated) to be applied to the reference samples. For example, if the smoothing filter is selected (e.g., activated), the interpolation filter is not selected (e.g., disabled) or vice versa.

Many encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

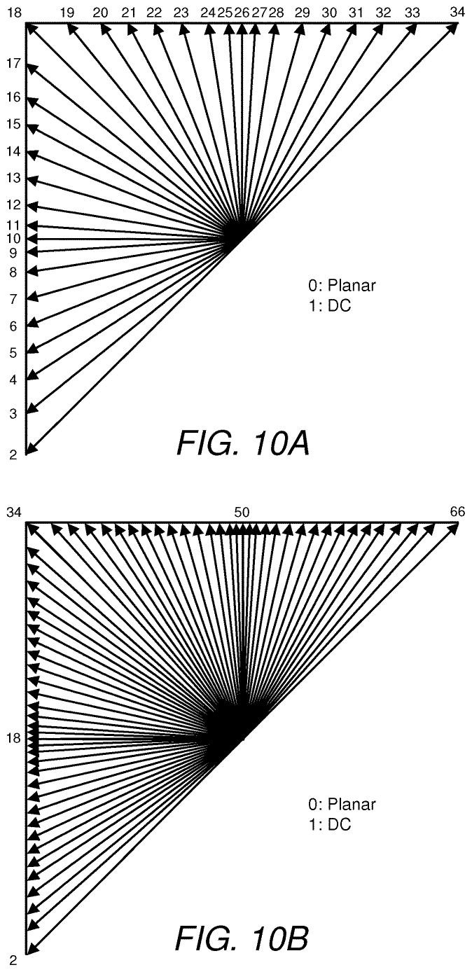

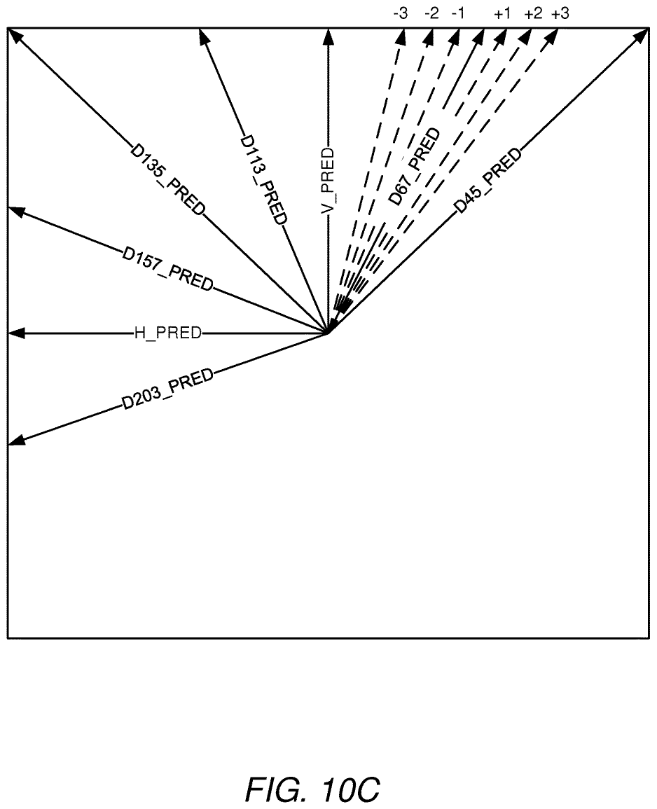

FIGS. 10A-B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

In some implementations of intra prediction modes (e.g., as supported by AV1), the angular modes can be defined by specifying a set of nominal modes and a set of angle delta offsets can be defined around each of the nominal modes. For example, there may be eight nominal angular prediction modes each having a set of angle delta offsets indexed between −3 and +3 with the nominal angle located at 0. FIG. 10C shows the eight nominal modes (in solid arrows) and the set of angle delta offsets around the D67_PRED nominal angle (in dotted arrows). The prediction angle can be derived by adding the offset to the associated nominal angle. As a result, there are 56 angular modes in AV1. Note that for small blocks, such as 4×4, 4×8, and 8×4, only nominal angular modes are applied. In addition to the 56 angular modes, there are five non-angular intra-prediction modes in AV1, including DC_PRED mode (averaging samples from reconstructed neighboring blocks), SMOOTH_V AND SMOOTH_H modes (using quadratic interpolation along the vertical and horizontal directions, respectively), SMOOTH mode (averaging the quadratic interpolation results along both directions), and Paeth mode (predicting each sample from its top, left and top left reference samples). Recursive intra-prediction modes may also be used where a coding block is divided into sub-blocks and each intra-predicted sub-block can be used to intra-predict the next sub-block.

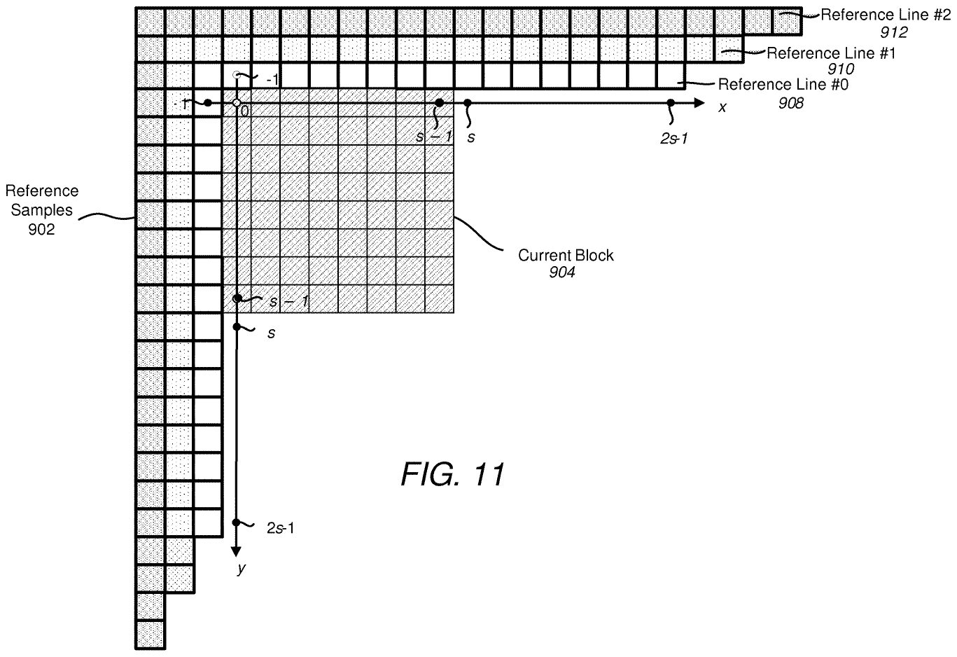

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902, from a reference line among a set of multiple reference lines (MRL) 908-912, in a two-dimensional x, y plane, where a sample may be referenced as p[x][y]. To simplify the prediction process, reference samples 902 may be placed in two, one-dimensional arrays. The reference samples 902 belonging to a reference line l from the set of MRL 908-912, above the current block 904, may be placed in the one-dimensional array ref₁[x]:

$${ref}_{1} [ x ] = p [ - l + x ] [ - l ] , ( x \geq 0 ) . \qquad ( 1 )$$

The reference samples 902 belonging to reference line l, to the left of current block 904, may be placed in the one-dimensional array ref₂[y]:

$${ref}_{2} [ y ] = p [ - l ] [ - l + y ] , ( y \geq 0 ) . \qquad ( 2 )$$

The variable l represents how many lines away the selected reference line is from current block. For example, if reference line #0 908 is selected, then l is set to 1 to indicate the reference line adjacent to current block 904. For example, if reference line #1 910 is selected, then l is set to 2. For example, if reference line #2 912 is selected, then l is set to 3.

In some examples, if MRL is not activated or selected, then reference samples 902 may be from reference line #0 908 that is immediately adjacent to current block 904. In this example, the variable/in Equations (1) and (2) is set to 1.

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at the location [x][y] in current block 904 and

$$v [ x ] [ y ] = ( s - y - 1 ) \cdot {ref}_{1} [ x ] + ( y + 1 ) \cdot {ref}_{2} [ s ] \qquad ( 5 )$$

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

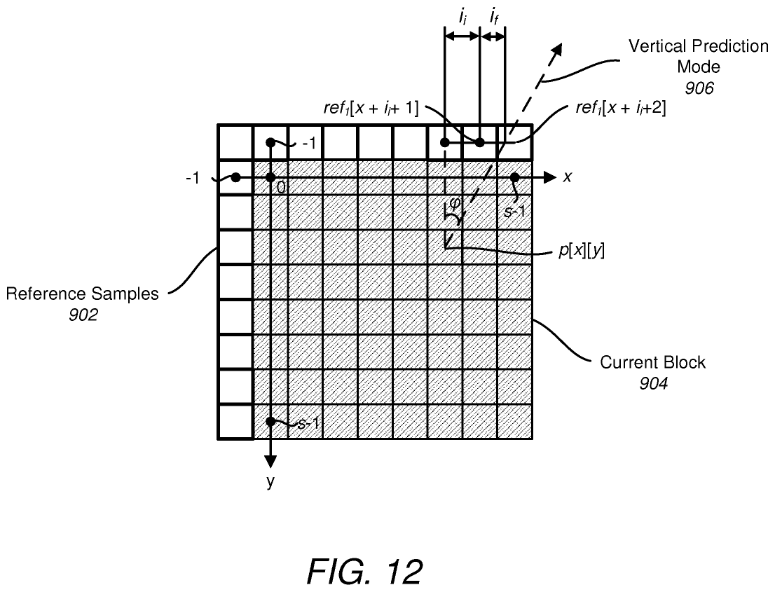

FIG. 12 shows an example of applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle φ with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 and shown as being from a reference line with reference line index of 0 for ease of illustration. Reference samples 902 may be from another reference line of the set of MRL, as explained in FIG. 9. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] . \qquad ( 7 )$$

iᵢ may be the integer part of the horizontal displacement of the projection point relative to the location [x][y]. iᵢ may be determined/calculated as a function of the tangent of the angle φ of the vertical prediction mode 906 as:

$${i}_{i} = ⌊ ( y + 1 ) \cdot tan φ ⌋ . \qquad ( 8 )$$

i_{f} may be the fractional part of the horizontal displacement of the projection point relative to the location [x][y] and may be determined/calculated as:

$${i}_{f} = ( ( y + 1 ) \cdot tan φ ) - ⌊ ( y + 1 ) \cdot tan φ ⌋ , \qquad ( 9 )$$

where └⋅┘ is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

$$p [ x ] [ y ] = ( 1 - {i}_{f} ) \cdot {ref}_{2} [ x + {i}_{i} + 1 ] + {i}_{f} \cdot {ref}_{2} [ y + {i}_{i} + 2 ] . \qquad ( 10 )$$

iᵢ may be the integer part of the vertical displacement of the projection point relative to the location [x][y]. iᵢ may be determined/calculated as a function of the tangent of the angle φ of the horizontal prediction mode as:

$${i}_{i} = ⌊ ( x + 1 ) \cdot tan ϑ ⌋ . \qquad ( 11 )$$

i_{f} may be the fractional part of the vertical displacement of the projection point relative to the location [x][y]. i_{f} may be determined/calculated as:

$${i}_{f} = ( ( x + 1 ) \cdot tan φ ) - ⌊ ( x + 1 ) \cdot tan φ ⌋ , \qquad ( 12 )$$

where └⋅┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] [ y ] = {\sum }_{i = 0}^{3} fT [ i ] \cdot {ref}_{1} [ x + iIdx + i ] , \qquad ( 13 )$$

where fT[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} fT [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC and/or including extended intra prediction modes from WAIP for rectangular blocks. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples, generated from reference samples 902 of a reference line (e.g., from a set of MRL), determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode and the associated reference line to encode the current block based on a rate-distortion measure (e.g., Lagrangian rate-distortion cost) determined using the prediction errors. The encoder may signal, in the bitstream to a decoder for decoding of the current block, an indication of the determined/selected intra prediction mode and an indication of the associated MRL index (which may indicate a reference line index). The encoder may also signal in the bitstream to the decoder a corresponding prediction error (e.g., residual) of the intra prediction mode.

A decoder may determine/predict samples of a current block being decoded (e.g., current block 904) for an intra prediction mode. For example, a decoder may receive an indication of a reference line (e.g., a reference line index or an MRL index associated with the reference line index) and an intra prediction mode (e.g., an angular intra prediction mode) from an encoder for a current block. The decoder may retrieve a set of reference samples and perform intra prediction based on the MRL index and the intra prediction mode indicated by the encoder for the current block in a similar manner (e.g., as described above for the encoder). For example, the decoder may obtain the reference samples from a reference line indicated/identified by the decoded MRL index. In some examples, when MRL is not enabled/activated/selected, the reference line has reference line index 0 and is immediately adjacent to the current block. In these examples, no indication of MRL index is signaled.

The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other decoder-side means (e.g., by applying template-based intra mode derivation (TIMD) tool/technique).

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

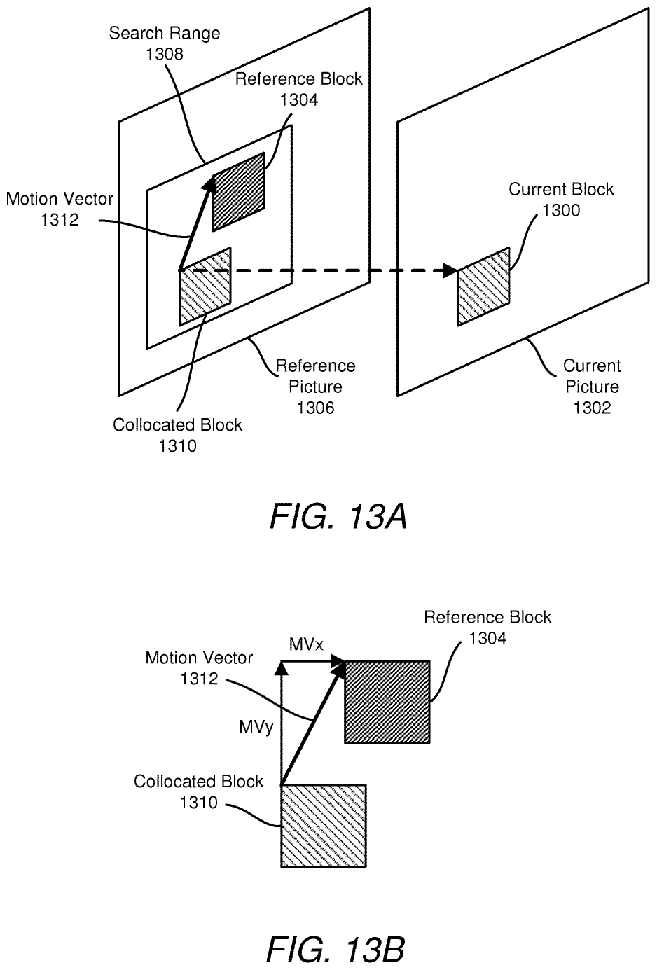

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306. The reference frames can include different types of frames. For example, in some implementations (e.g., such as in AV1), up to seven frames can be used as reference frames and there are four types of frames, including LAST frame (a frame that was displayed in the near past), BWD frame (a frame that will be displayed in the future), GOLDEN frame (a frame that was displayed in the distant past), and ARF frame (a frame from either the past or the future).

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction or single reference inter prediction.

Inter prediction of a current block, using bi-prediction or compound prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction/single reference prediction and/or bi-prediction/compound prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

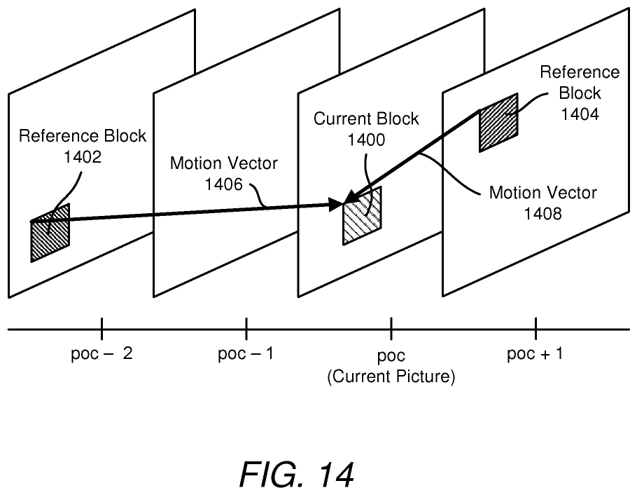

FIG. 14 shows an example of bi-prediction/compound prediction. Two reference blocks 1402 and 1404 may be used to predict a current block 1400. For example, reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC) or a display order. The second picture may succeed the current picture in terms of the POC or the display order. In other examples, the reference pictures may both precede or both succeed the current picture in terms of POC or the display order. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS) or a set of parameters at a similar level. The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy) that indicates a position relative to a position of the current block being coded, the MVD may be represented by two components MVDₓ and MVD_{y}. MVDₓ and MVD_{y} may be determined/calculated as:

$${MVD}_{x} = {MV}_{x} - {MVP}_{x} , \qquad ( 15 )$$

$${MVD}_{y} = {MV}_{y} - {MVP}_{y} . \qquad ( 16 )$$

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

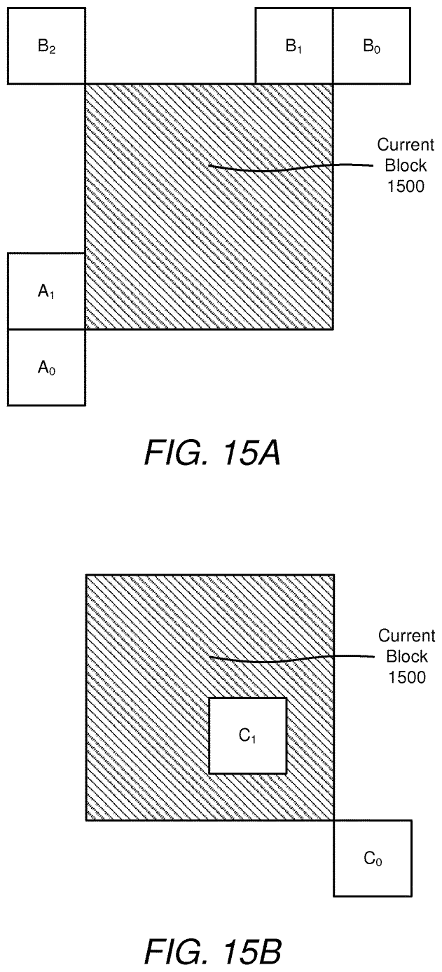

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

In some examples (e.g., AV1), a list of derived MV predictors may be generated by pooling the spatial and temporal MV candidates and ranking them based on weightings determined by evaluating each of the candidates. Up to four candidates may be added to the list of MV predictors, which may also be referred to as the dynamic reference list (DRL). The DRL may be used in dynamic MV prediction modes.

Inter prediction may be performed in other ways and variants than those described herein. For example, motion information prediction techniques other than AMVP and merge mode may be used. While various examples herein correspond to inter prediction modes, such as used in HEVC and VVC or AV1, the methods, devices, and systems as described herein may be applied to/used for other inter prediction modes (e.g., as used for other video coding standards/formats such as VP8, VP9, etc.). History-based motion vector prediction (HMVP), combined intra/inter prediction mode (CIIP) or compound inter-intra prediction, warped motion compensation, overlapped block motion compensation (OBMC), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, WVC, AV1, and/or any other coding standards/formats/protocols) to exploit correlation between blocks of samples within a same picture (e.g., of screen content videos). The prediction technique may be intra block copy (IBC or IntraBC) or current picture referencing (CPR). An encoder may apply/use a block matching technique (e.g., similar to inter prediction) to determine a displacement vector (e.g., a block vector (BV). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking, SAO filtering, CDEFs, and/or LR filters). In some examples, the reference block may be restricted to a certain area. For example, in AV1, if the top-left pixel coordinate of a superblock is (x0, y0), IntraBC prediction is available at pixel position (x, y) only if the value of the vertical coordinate y is less than y0 and the value of the horizontal coordinate x is less x0+2(y0−y). Further, due to hardware write-back delays, the immediate reconstructed area may not be accessible by IntraBC prediction.

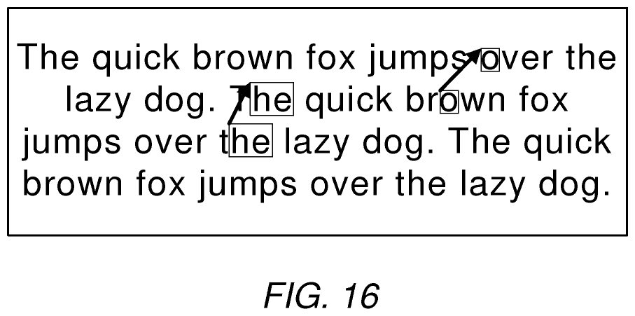

FIG. 16 shows an example of IBC (e.g., an IBC mode or an IntraBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy) that indicates a position relative to a position of the current block being coded, the BVD may be represented by two components BVDₓ and BVD_{y}. BVDₓ and BVD_{y} may be determined/calculated as:

$${BVD}_{x} = {BV}_{x} - {BVP}_{x} , \qquad ( 17 )$$

$${BVD}_{y} = {BV}_{y} - {BVP}_{y} . \qquad ( 18 )$$

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

Local illumination compensation (LIC) is a prediction technique for reducing prediction errors of prediction blocks generated for coding blocks (e.g., a current block). LIC models illumination variation between a current block and its reference block as a function of illumination variation between a current block template and a reference block template. The parameters of the LIC model (e.g., the LIC function) are denoted by a scale α and an offset β, to form the linear equation (19), shown below, that is used to compensate illumination variations in the reference block. P_{ref} is a sample (e.g., a reference sample) in the reference block indicated (e.g., pointed to) by a displacement vector (motion vector (MV)) in inter prediction. P_{pred} is a predicted sample corresponding to the reference sample (P_{ref}) being filtered, e.g., in accordance with illumination variation modeled by the parameters scale α and offset β, which may be determined according to equation (19) below.

$${P}_{pred} = α * {P}_{ref} - β \qquad ( 19 )$$

The parameters α and β (e.g., also referred to as coefficients) are derived based on a template associated with the current block (referred to as a current block template or current template) and a corresponding template associated with the reference block (referred to as a reference block template or reference template). Consequently, LIC incurs no additional signaling overhead, other than for an LIC flag that may be signaled to indicate the use of LIC (e.g., whether LIC is enabled or disabled for an inter-mode coded coding unit (CU).

The application of LIC to the reference block associated with a current block comprises adjusting reference samples by multiplying the reference samples (respectively the values of the samples) with a (respectively a value of α) and adding β (respectively a value of β) in accordance with the above-described linear equation (19) for compensating for local illumination differences. The parameters α and β are derived from samples in the templates of the current block and the reference block to reduce differences between samples of the current template and filtered samples of the reference template. For example, a least mean squares method may be used to select (e.g., determine or derive) the parameters to reduce the differences, but other methods such as a sum of absolute differences (SAD), a sum of absolute transformed differences (SATD), or a sum of squared errors (SSE), may also be used. The parameters α and β may be derived using all samples in the templates, a subset of samples in the templates, or subsets of samples in the templates.

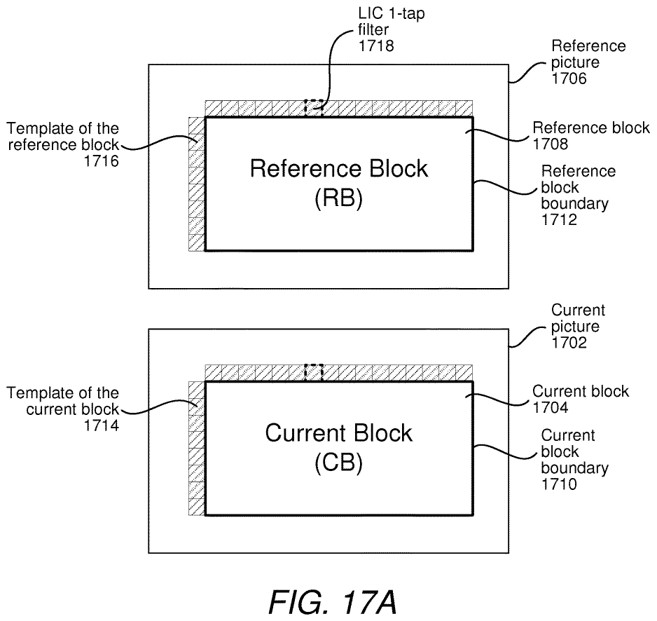

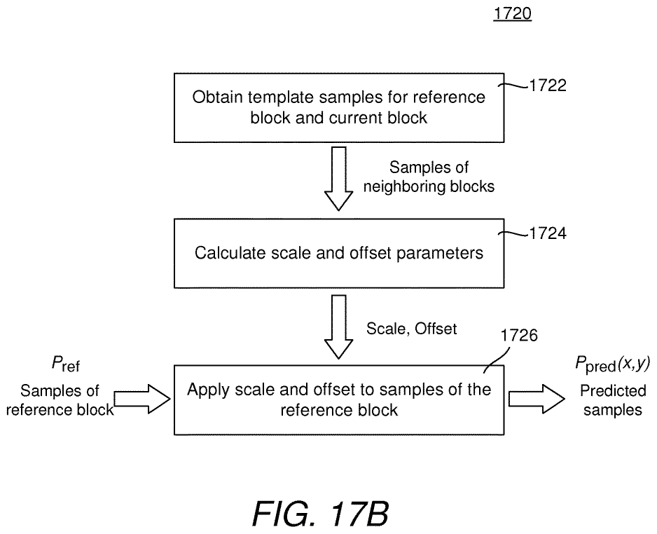

FIG. 17A shows an example of a current block and a reference block with corresponding templates used in determining scale and offset parameters for local illumination compensation (LIC) during inter prediction, according to some embodiments. FIG. 17A illustrates a current block (CB) and a reference block (RB) with their corresponding templates that may be used in determining parameters α and β for LIC for inter prediction. A current block 1704 is shown in a current picture 1702 and a reference block 1708 is shown in a reference picture 1706. In an example sequence of pictures (e.g., related to inter prediction), the current block 1704 may correspond to the current block 1400 shown in FIG. 14 and the reference block 1708 may correspond to either reference block 1402 or reference block 1404 shown in FIG. 14. Corresponding current template 1714 and reference template 1716 are shown in relation to the current block 1704 and reference block 1708, respectively. The current template 1714 comprises neighboring samples adjacent to the current block boundary (current block border) 1710 at the left edge and the top edge of the current block 1704. The length of the current template 1714 is the sum of the lengths of the left column and the top row of samples in the current block 1704. The reference template 1716 comprises neighboring samples adjacent to the reference block boundary (reference block border) 1712 at the left edge and the top edge of the reference block 1708. The length of the reference template 1716 is the sum of the lengths of the left column and the top row of samples in the reference block 1708. The templates 1714 and 1716 have a height of 1 sample (i.e., the left portion of each template 1714 and 1716 is a single column of samples, and the top portion of each template 1714 and 1716 is a single row of samples). In other examples, templates 1714 and 1716 may have a height of more than 1 sample (e.g., 2, 3, 4, etc. samples).

The scale parameter, α, may be determined according to equation (20) below.

$$scale = \frac{n \sum {T}_{ref} ( i ) {T}_{rec} ( i ) - \sum {T}_{ref} ( i ) \sum {T}_{rec} ( i )}{n \sum {T}_{ref}^{2} ( i ) - {( \sum {T}_{ref} ( i ) )}^{2}} \qquad ( 20 )$$

The offset parameter, β, may be determined according to equation (21) below.

$$offset = \frac{\sum {T}_{rec} ( i ) - scale \cdot \sum {T}_{ref} ( i )}{n} \qquad ( 21 )$$

In the above two equations (20) and (21), n is the number of samples, T_{rec}(i) is the i^{th} sample of the current template (as noted above, the current template is the template of the current block), and T_{ref}(i) is the i^{th} sample of the reference template (as noted above, the reference template is the template of the reference block). The current block may also be referred to as the reconstructed block when decoded by the decoder. In an example, when the current block 1704 has not yet been reconstructed, the neighboring blocks (to which the samples of the current template 1714 belong) adjacent to the left edge and the top edge of the current block 1704 have already been reconstructed. Samples of reference template 1716 and current template 1714 are reconstructed samples of reference picture 1706 and current picture 1702, respectively.

FIG. 17B shows an example process for generating a predicted block when LIC is used during inter prediction, according to some embodiments. FIG. 17B shows a method 1720 to generate (e.g., calculate) a predicted block when performing inter prediction using LIC. The method 1720 may be performed at an encoder (e.g., encoder 200 of FIG. 2) and/or a decoder (e.g., decoder 300 of FIG. 3).

At operation 1722, template samples for the current block and the reference block are obtained. As illustrated in FIG. 17A, LIC uses a one-tap filter model 1718 to sample templates 1714 and 1716. The one-tap filter model 1718 is used to obtain each respective template sample i from the same relative position in the two templates 1714 and 1716.

At operation 1724, the template samples (e.g., neighbor samples of the reference block and the current block) are used in equation (20) above to calculate the scale parameter. In some implementations, as shown above in equation (21), the offset parameter is calculated using the calculated scale parameter. Accordingly, an LIC filter may be determined that corresponds to the one-tap LIC model with the calculated scale and offset parameters.

In some examples, after scale α and offset β parameters are determined by applying the one-tap filter model 1718 to the current template 1714 and the reference template 1716 (as illustrated in FIG. 17A), at operation 1726, the parameters (i.e., scale α and offset β) are applied to respective reference samples P_{ref} to obtain prediction samples P_{pred} (samples of the prediction block) in accordance with the equation (19) shown above.

In some examples, when method 1720 is used at an encoder, the determined predicted block may be subtracted from the current block to obtain the prediction errors (e.g., a residual or a residual block) that are subsequently encoded in a bitstream. When method 1720 is used at a decoder, the prediction error received in the bitstream may be added to the determined predicted block to obtain the current block. The predicted block determined based on LIC may have improved illumination variation relative to the reference block and may consequently yield smaller prediction errors that would be encoded in the bitstream.

Further examples may not be limited to including all samples adjacent to the left border and the top border of the block in the LIC parameter calculation and instead may include only a subset of the samples in some embodiments. LIC may be used with inter prediction in the Enhanced Compression Model (ECM) software algorithm that is currently under coordinated exploration study by the Joint Video Exploration Team (JVET) of ITU-T Video Coding Experts Group (VCEG) and ISO/IEC MPEG as potential enhanced video coding technology beyond the capabilities of VVC. Although the present disclosure describes LIC for inter prediction, many of the described embodiments are equally applicable to intra prediction in which prediction blocks for a current block are generated from the same picture as that of the current block.

In existing approaches, illumination variations in reference blocks sometimes yield large prediction errors. LIC was proposed to improve inter prediction when such illumination variation exists in the reference block. Further improvement in addressing illumination variations in the reference block may be obtained by, instead of the one-tap filter in LIC, using a multiple-tap filter for illumination compensation so that correlations between multiple template samples may be captured and addressed by the use of the filter. Further, in some examples, complex non-linear filter models and/or non-linear functions applied to components of linear filter models may be used to generate prediction blocks that better compensate for illumination variations between reference blocks and corresponding current blocks.

In some examples, a plurality of filter models (e.g., which may include one or more multi-parameter filter models) are provided from which one filter model may be selected for LIC in inter prediction. Addition of multiple possible filter models increases flexibility at the encoder and enables an appropriate filter model to be selected to cater for different characteristics of content in video blocks. In some examples, the decoder may receive an indication of a filter model of the plurality of filter models, as determined and signaled by the encoder, to be used for LIC in inter prediction. In other examples, the encoder and decoder may reciprocally (e.g., independently and identically) derive that filter model from the plurality of filter models such that no signaling of that filter model is needed in the bitstream.

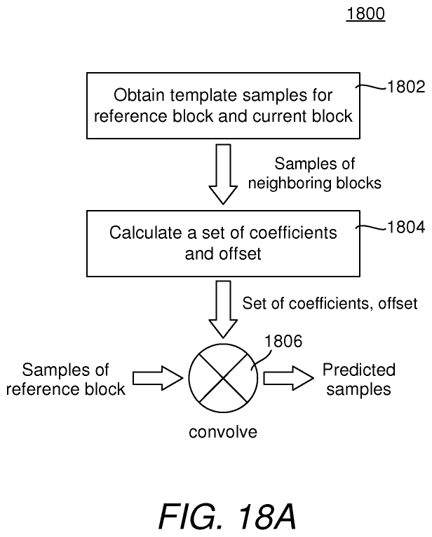

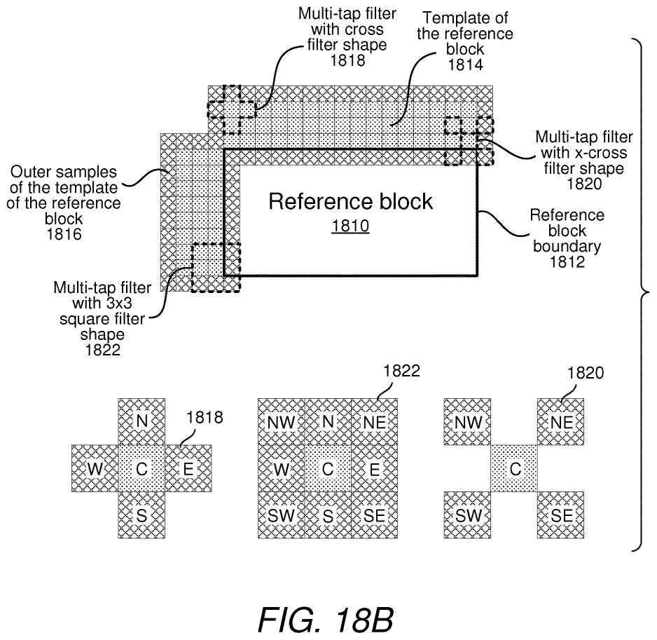

FIG. 18A shows a process for generating a predicted block by applying an illumination compensation function (e.g., a filter model) that uses a multiple-tap filter to generate predicted samples from samples of the reference template, according to some embodiments. FIG. 18A shows an example of a method 1800 for generating (e.g., calculating) a predicted block by using an illumination compensation function (e.g., a filter model) that uses a multiple-tap filter (e.g., multi-parametric reference filter (MPRF) to sample the current template and the reference template. The method 1800 may be performed by an encoder, for example, encoder 200 shown in FIG. 2, and/or a decoder, for example, decoder 300 shown in FIG. 3. At the encoder, the current block may be subtracted from the predicted block to obtain the prediction error (e.g., a residual or a residual block) that is then encoded into a bitstream. At the decoder the prediction error received in a bitstream may be added to the prediction block to obtain the current (reconstructed) block. As illustrated in FIG. 18A, at operation 1802, template samples from a reference template are obtained using a multiple-tap filter model.

FIG. 18B shows an example reference template and example multiple-tap filter models that may be applied to the reference template to generate a multi-tap filter, according to some embodiments. FIG. 18B illustrates an example reference template 1814 and example multiple-tap filter models 1818, 1820, and 1822 that may be used on the reference template 1814 to obtain a plurality of reference template samples for each sample location in the reference template. Corresponding current template samples are obtained for each sample location in the current template. In examples, the reference template 1814 extends over the left edge and the top edge of the boundary 1812 of the reference block 1810. In some examples, the reference template and the current template have identical size, shape and relative placement relative to their respective blocks.

In some examples, the templates (the current template and the reference template) may have a height greater than 1 sample. For example, template 1814 may have a height of 3 (3 samples). Additionally, in contrast to the one-tap filter used in conventional LIC, example embodiments use a multiple-tap filter model such as, for example, one of multiple-tap filter models 1818-1822. The cross-shaped 5-tap filter model 1818 and the x-cross shaped 5-tap filter model 1820 each obtains 5 samples (e.g., a target sample and four neighboring/adjacent samples) at each template sample location in the template. The 3×3 square-shaped 9-tap filter model 1822 obtains 9 samples (e.g., a target sample and all neighboring/adjacent samples) at each template sample position. The example filter models 1818-1822 each illustrates an arrangement of a plurality of spatial components adjacent to a center spatial component C (which may correspond to a template sample location). In the illustrations in FIG. 18B, each filter spatial component is indicated relative to the center spatial component C as north N, northeast NE, east E, southeast SE, south S, southwest SW, west W, or northwest NW. Each filter shape and size may yield different illumination compensation results when applied to a reference block, based on the suitability of the filter's size and shape to capture the block's image characteristics.

Due to the size and shape of the multiple-tap filters such as, for example, provided by filter models 1818-1822, the template samples obtained by the multiple-tap filter may include some samples that are immediately adjacent to the template. FIG. 18B illustrates outer samples 1816 some of which may be obtained as template samples when any of the multiple-tap filter models 1818-1822 are used on template 1814. For example, in the illustration shown in FIG. 18B, spatial component C of filter model 1818 is positioned within the template 1814 such that spatial components N and W of filter model 1818 may be outside of template 1814 and overlay outer samples 1816. The illustrated position of filter model 1820 within template 1814 results in the filter model 1820 overlapping 3 outer samples 1816. The illustrated position of filter model 1822 within template 1814 results in the filter model 1822 overlaying 5 outer samples 1816.

Returning to method 1800 (as illustrated in FIG. 18A), at operation 1804, the template samples (neighbor samples of the current block and the reference block) obtained at operation 1802, are used to calculate multiple spatial parameters (e.g., coefficients of the filter model). For example, in some embodiments, a respective spatial parameter is calculated for each tap in the applied filter. When, for example, 5-tap filter model 1818 is the filter that is used on the reference template, 5 spatial parameters are calculated, and when the 9-tap filter model 1822 is the filter model that is used on the reference template, 9 spatial parameters are calculated. The spatial parameter for a particular filter tap spatial component may be calculated by aggregating template samples corresponding to that filter tap spatial component according to an equation such as, for example, equation (20). The calculation of spatial parameters for the multiple-tap filter model may be thought of as similar to the calculation of the scale parameter for the one-tap filter as shown in equation (20).

An offset parameter (also referred to as a bias term or a bias component) may be calculated based on one or more aspects of the blocks and/or the calculated spatial parameters. For example, in some embodiments the offset is calculated based on the calculated spatial parameters by using an equation such as equation (21) adapted for the multiple-tap filter model.

At operation 1806, the set of coefficients (the plurality of spatial parameters) and the offset parameter calculated at operation 1804 are applied to respective reference samples to obtain respective predicted samples of the predicted block. This operation may be referred to as applying the multiple-tap filter corresponding to the multiple-tap filter model being applied to the reference block.

The calculation of the respective samples of the predicted block may be done in accordance with an equation that convolves the respective coefficients in the calculated set of coefficients with reference samples. An example equation for convolving the set of coefficients and a reference sample to obtain a predicted sample is shown in equation (22) below.

$$p ( x , y ) = \sum {a}_{i} r ( x , y ) + \sum {b}_{j} {f}_{0} ( r ( x , y ) ) + \sum {c}_{k} {f}_{1} ( {r}^{′ ( x , y )} ) + \sum {d}_{l} {f}_{2} ( {r}^{″ ( x , y )} ) + offset . \qquad ( 22 )$$

Here, {aᵢ, bⱼ, cₖ, cᵢ} is the set of coefficients, f₀(⋅), f₁(⋅), f₂(⋅) are non-linear functions, r(x, y) are reference samples, r′(x, y) are gradients (derivatives) of reference samples, and r″(x, y) are second-order derivatives of reference samples. Equation (22) shows an example manner in which a set of 4 calculated coefficients is convolved with reference samples to obtain predicted samples. Each of the coefficients aᵢ, bⱼ, cₖ, cₗ may be obtained in a manner similar to the obtaining of the scale parameter described in relation to equation (20) by using a collection of template samples (current template samples and reference template samples). An example manner in which coefficients aᵢ, bⱼ, cₖ, cₗ may be determined is described below.

When using equation (22) to determine coefficients aᵢ, bⱼ, cₖ, cₗ, the r(x,y) is a reference template sample and p(x,y) is a current template sample. The first term Σaᵢr(x,y) comprises N, E, S, W, and C samples. Σaᵢr(x,y) may be expanded, e.g., as per equation (23) below.

$$\sum {a}_{i} r ( x , y ) = {a}_{0} r ( x , y - 1 ) + {a}_{1} r ( x + 1 , y ) + {a}_{2} r ( x , y + 1 ) + {a}_{3} r ( x - 1 , y ) + {a}_{4} r ( x , y ) \qquad ( 23 )$$

In equation (23), the template samples corresponding to N, E, S, W, and C spatial components of the 5-tap filter model 1818 are denoted as r(x,y−1), r(x+1,y), r(x,y+1), r(x−1,y), and r(x, y), respectively. For the following terms comprising ‘b’, ‘c’ and ‘d’ coefficients, these coefficients are applied to some non-linear functions of the N, E, S, W, and C samples (second term Σbⱼf₀(r(x, y)), non-linear functions of gradients of the samples (third term Σcₖf₁(r′(x,y))) and non-linear functions of second-order derivatives of the samples (fourth term Σd₁f₂(r″(x,y))).

f( ) could be applied to a set of gradient values

$$\{ {r}_{x}^{′} ( x , y ) , {r}_{y}^{′} ( x , y ) , {r}_{xy}^{′} ( x , y ) \} .$$

One example of a such a non-linear function is shown by equation (24) below.

$$f ( x , y ) = √ ( {{r}_{x}^{′} ( x , y )}^{2} + ( {{r}_{y}^{′} ( x , y )}^{2} \qquad ( 24 )$$

Another example of such a non-linear function is a clipping function defined for some threshold value T: f(x,y)=min(0,max(T,r′(x, y)) or f(x, y)=min(0, max(T,r″(x, y)).

Threshold value T could be selected from the reference area samples, e.g., by taking a mean value in the reference area. Another example is a square function, defined, e.g., as

$$f ( x , y ) = {{r}_{x}^{′} ( x , y )}^{2} or f ( x , y ) = {{r}_{y}^{′} ( x , y )}^{2} .$$

Another example is a maximum of squares function:

$$f ( x , y ) = max ( {{r}_{x}^{′} ( x , y )}^{2} , {{r}_{y}^{′} ( x , y )}^{2} .$$

Derivation of the coefficients in presence of the non-linear terms may be performed in a similar way as it is done for the linear terms. Specifically, a system of linear equations may be composed and further solved, e.g., using a Gaussian elimination technique. Hence, though operations that are applied to the reference template samples could be non-linear, the filter itself may be linear because its coefficients are fixed after they are determined and may not depend on the reference block samples.

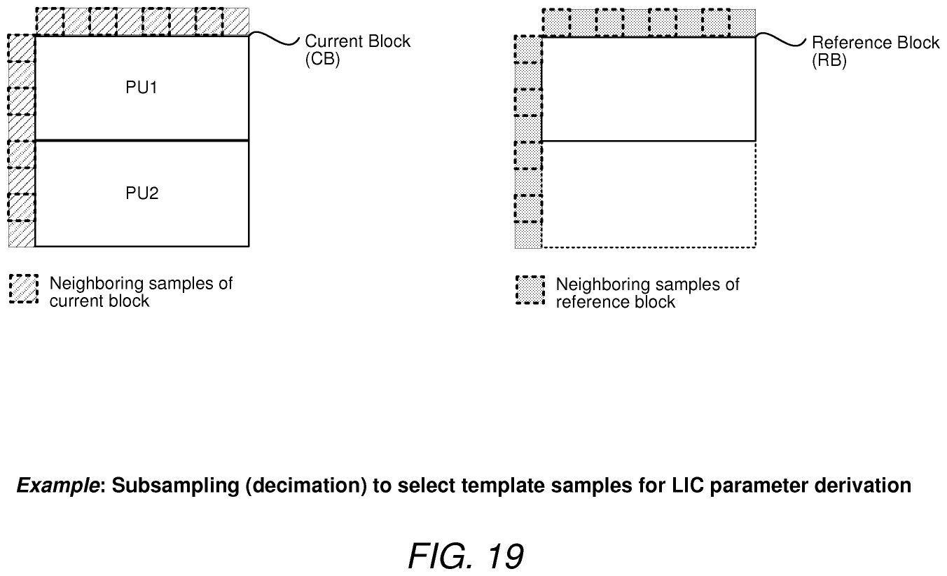

FIG. 19 shows an example of subsampling (decimation) to select template samples for LIC parameter derivation, according to some embodiments. Local Illumination Compensation (LIC) is based on a linear model for illumination changes, using a scaling factor a and an offset b. LIC may be enabled or disabled adaptively for each inter-mode coded coding unit (CU) or current block (CB). When LIC applies for a CU or CB, a video coder may employ a least square error method to derive the parameters a and b by using the neighboring samples of the current CU or and their corresponding reference samples of a reference block (RB).

As illustrated in FIG. 19, a video coder may use the subsampled (e.g., 2:1 sub-sampling, 4:1 sub-sampling, etc.) neighboring samples of the CU or CB. In an example, the video coder may use the corresponding pixels (identified by motion information of the current CB or sub-CB) in the reference picture as shown in FIG. 19. The video coder may derive the IC parameters and may apply the IC parameters for each prediction direction separately. When a CB is coded with merge mode, a video coder may copy the LIC flag from neighboring blocks, in a way similar to motion information copy in merge mode. Otherwise, a video encoder may signal an LIC flag for the CU to indicate whether LIC applies or not.

In existing technologies, a decision on how many samples from each template will be selected for the process of LIC parameter derivation does not depend on the actual availability of these templates, even though a sub-sampling (or decimation) factor applied to template sample may be defined by several variables including a side length(S) of a current block (CB), S=min{cuHeight, cuWidth}, where cuHeight and cuWidth are the height and width of a CU or CB, respectively. One of the reasons to use a subsampling process is to constrain the number of samples involved in the LIC parameter derivation process to be a power of two (2). For example, if one of the template sides is unavailable, the overall number of template samples available should also be determined to be a power of two (2). In an example, constraining the number of samples involved in the LIC parameter derivation process to be a power of two (2) may reduce computational complexity in the calculations performed by an encoder or decoder.

Embodiments of the present disclosure are related to an approach for determining, based on first available template samples of a current block (CB), a down-sampling pattern for the current template of the CB and a reference template of a reference block (RB), and deriving parameters of a filter based on the down-sampling pattern, the first available template samples, and second template samples of the reference template. In example embodiments, an encoder or decoder may determine, based on illumination compensation being enabled for a reference block (RB), first available template samples of a current template of a current block (CB). The encoder or decoder may further determine, based on the first available template samples, a down-sampling pattern for the current template of the CB and a reference template of the RB. The encoder or decoder may further derive parameters of a filter based on the down-sampling pattern, the first available template samples, and second template samples of the reference template. The encoder or decoder may further apply the filter to the RB to generate a prediction block. The encoder may further encode, in a bitstream, a residual based on the prediction block and the CB. The decoder may further reconstruct the CB based on the prediction block. These and other features of the present disclosure are described further below.

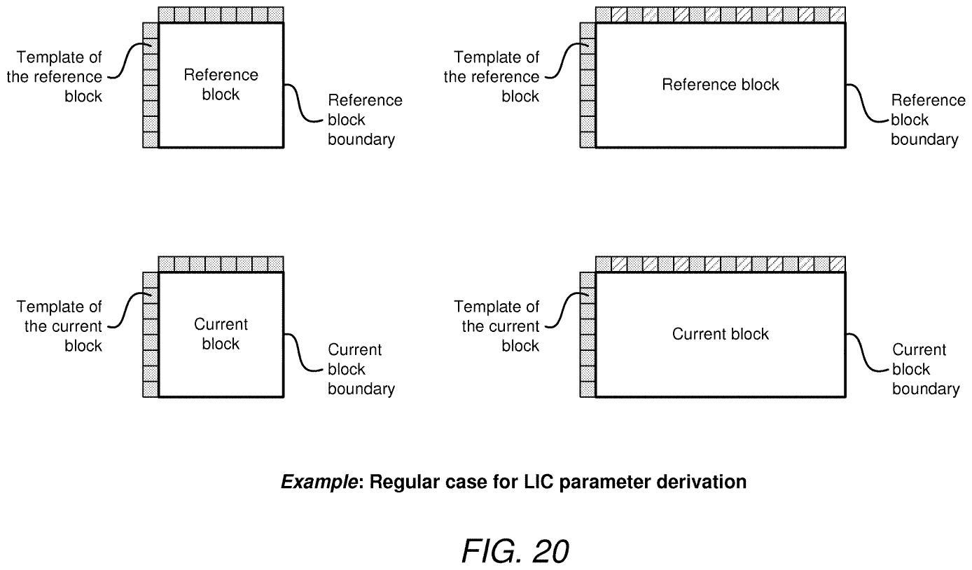

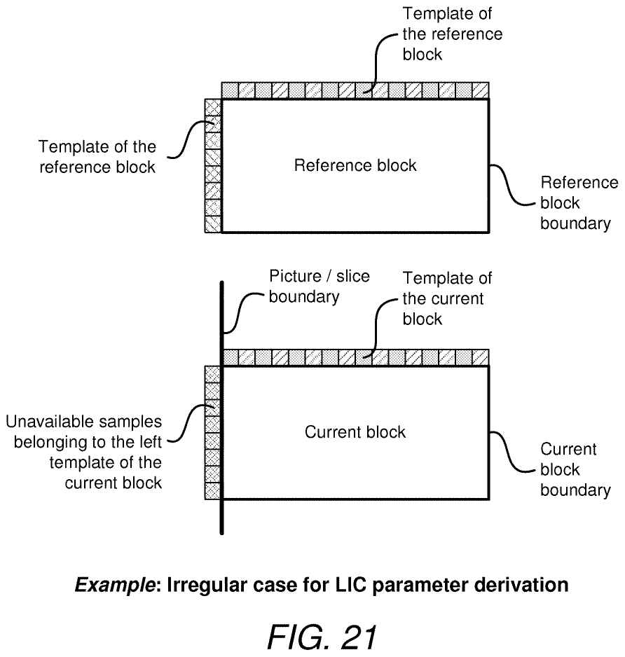

FIG. 20 shows an example of subsampling (decimation) to select template samples for a first regular case for LIC parameter derivation, according to some embodiments. As illustrated in FIG. 20, if a left side and a top side of a current template of a current block (CB) are both available, and the dimensions of the left side and the top side of the CB are the same, then each sample of a left side and a top side of a reference template of a reference block (RB) may be selected for LIC parameter derivation. In another example illustrated in FIG. 20, if a top side of the current template the CB is longer than the left side of the current template of the CB, then the top side of the templates of the CB and the RB may be sub-sampled based on a sampling pattern such that the number of samples selected from the left side and the top side of the templates of the CB and the RB are equal to each other and, for example, corresponding to the same power of two (2).

FIG. 21 shows an example of subsampling (decimation) to select template samples for a second irregular case for LIC parameter derivation, according to some embodiments. As illustrated in FIG. 21, if a left side of a current template of a current block (CB) is unavailable, then the samples of a left side a reference template of a reference block (RB) may be excluded from LIC parameter derivation. In another example illustrated in FIG. 21, if a top side of the current template the CB is longer than the left side of the current template of the CB, then the top side of the templates of the CB and the RB may be sub-sampled based on a sampling pattern such that the number of samples selected from the top side of the templates of the CB and the RB are equal to each other and, for example, corresponding to the same power of two (2).

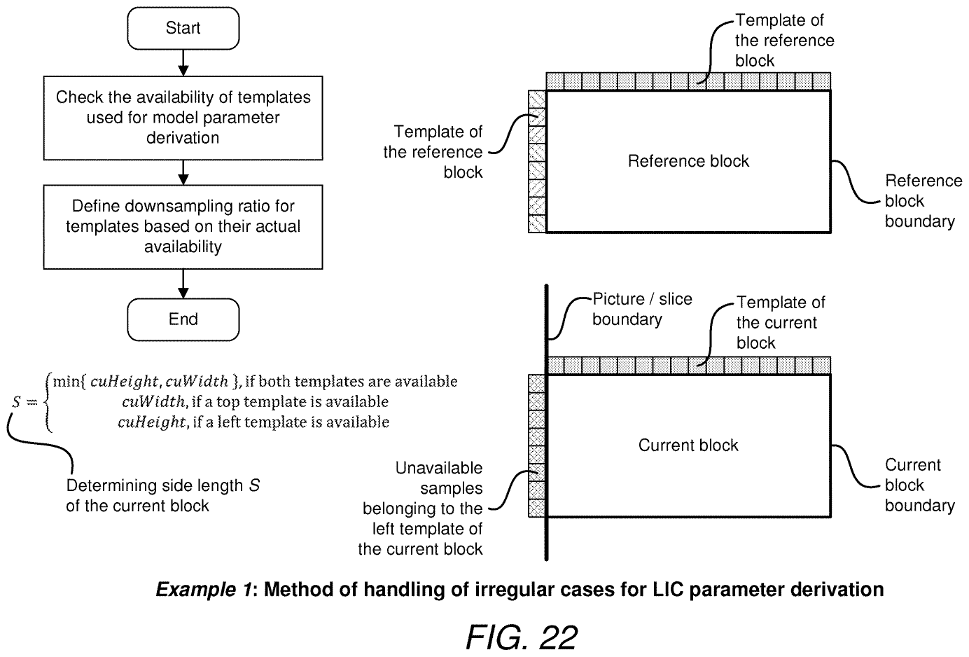

FIG. 22 shows an example of down-sampling or subsampling to select template samples for a first irregular case for LIC parameter derivation, according to some embodiments. As illustrated in FIG. 22, if a left side of a current template of a current block (CB) is unavailable, then the samples of a left side a reference template of a reference block (RB) may be excluded from LIC parameter derivation. In another example illustrated in FIG. 22, a process of down-sampling may include: firstly, checking the availability of templates used for model parameter derivation; and, secondly, defining a down-sampling ratio for templates based on their actual availability. In some examples, dependency of a subsampling process applied to LIC templates may be based on the actual availability of these templates. The checking of template availability is performed before making a decision on the down-sampling ratio of the templates used to derive model parameters. Further, for example, instead of using the length of the shorter side of a CU in both the regular case and irregular case, the length of the available side (S) of a CU in LIC parameter derivation may be used as is shown by equation (25) below.

$$S = \{ \begin{matrix}min \{ cuHeight , cuWidth \} , if both templates are available \\ cuWidth , if a top template is available \\ cuHeight , if a left template is available\end{matrix} \qquad ( 25 )$$

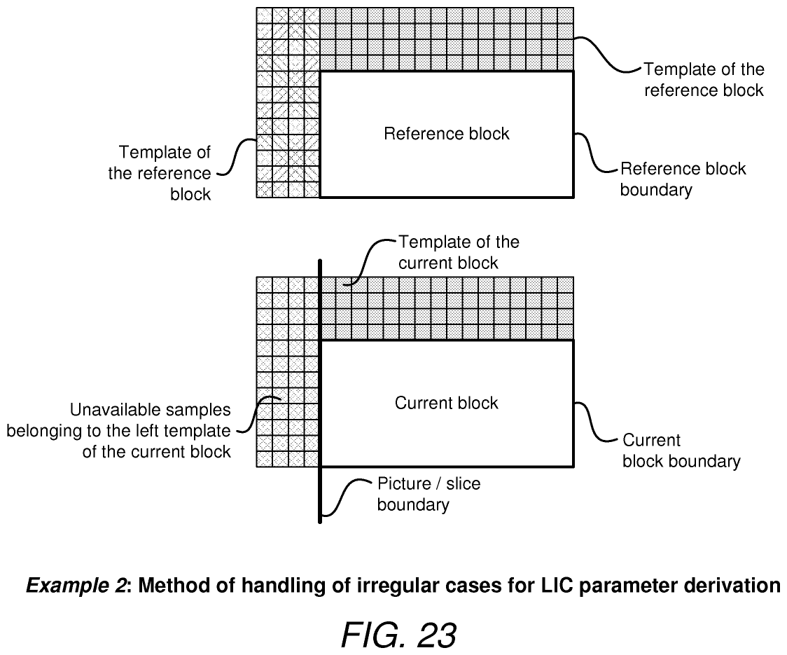

FIG. 23 shows an example of down-sampling or subsampling to select template samples for a second irregular case for LIC parameter derivation, according to some embodiments. FIG. 23 is similar to the example illustrated by FIG. 22, except that the templates of the CB and the RB may comprise more than one column of samples and more than one row of samples. For example, as illustrated in FIG. 23, the templates of the CB and the RB comprise four columns of samples on the left side and four rows of samples on the top side. Further examples, e.g., the process illustrated in FIG. 22, may be applicable to any still and moving picture coding method that uses templates for estimating or deriving model parameters and the templates are down-sampled (decimated) before estimating or deriving model parameters. Hence, further embodiments may be based on one or more of a CCLM (Cross-Component Linear Model), CCCM (Cross-Component Convolutional Model) including BVG-CCCM (Block Vector Guided CCCM), and CCRM (Cross-Component Residual Model).

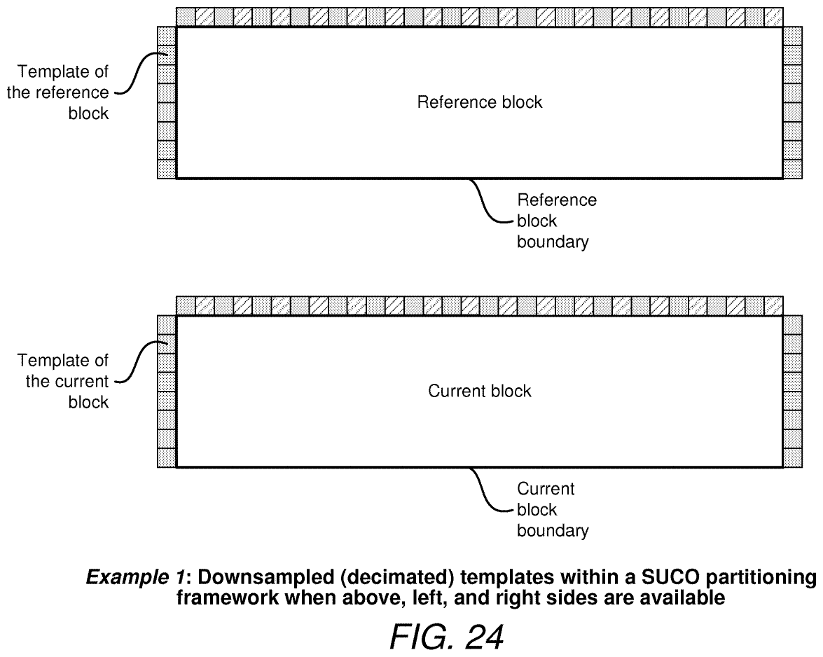

FIG. 24 shows an example of down-sampling or subsampling to select template samples within a split unit coding order (SUCO) partitioning framework when above, left, and right sides are available, according to some embodiments.

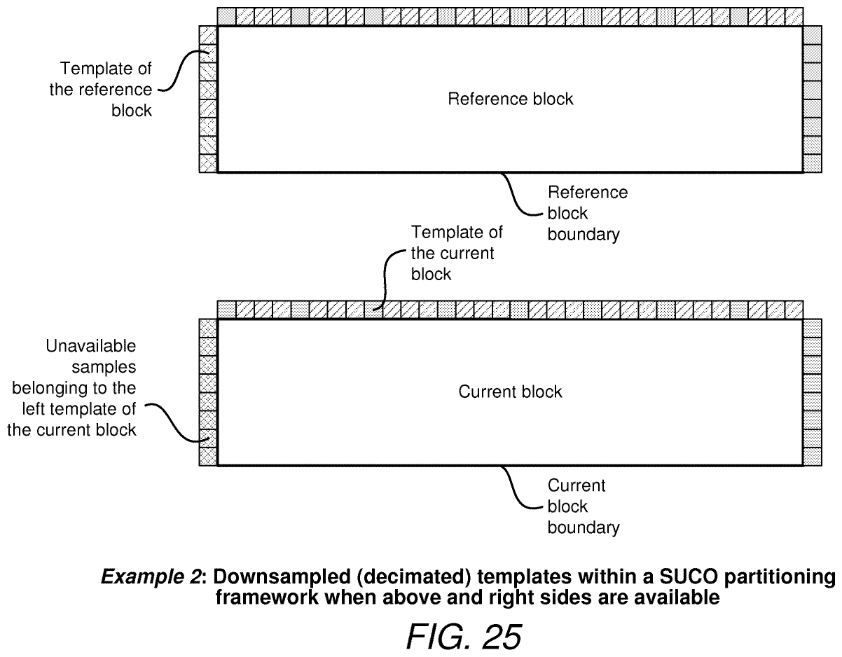

FIG. 25 shows an example of down-sampling or subsampling to select template samples within a SUCO partitioning framework when above and right sides are available, according to some embodiments.

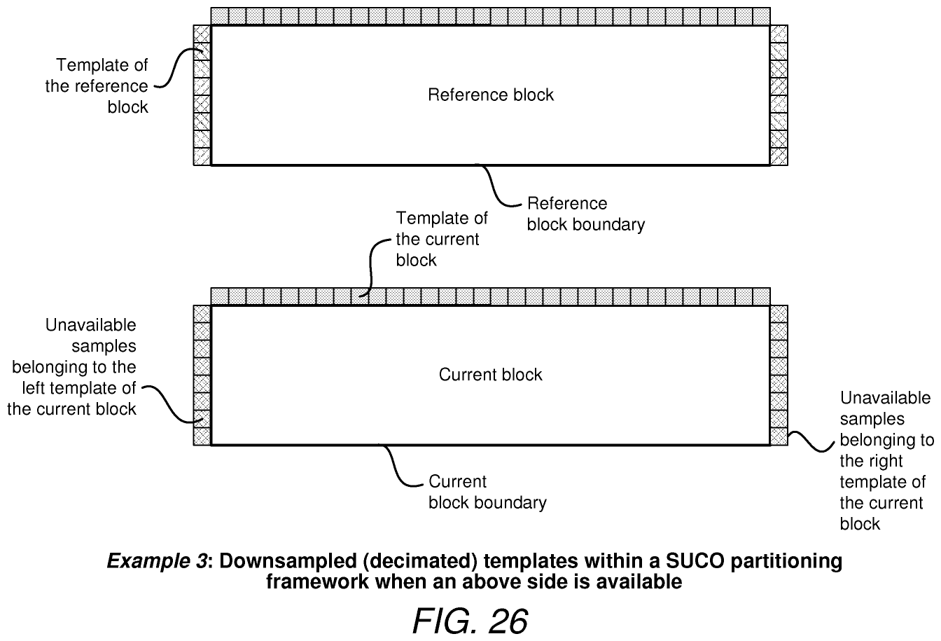

FIG. 26 shows an example of down-sampling or subsampling to select template samples within a SUCO partitioning framework when an above side is available, according to some embodiments.

In the examples illustrated by FIG. 24, FIG. 25, and FIG. 26, further embodiments comprise partitioning frameworks that are different from the multi-type tree (MTT) structure used in the H.266/VVC standard and the ECM exploration software. In particular, the Split Unit Coding Order (SUCO) framework adopted into the MPEG-5/EVC standard could be an example of such a framework. In contrast to MTT where prediction of a coding block is performed using left and above neighbor samples, SUCO enables more flexible processing order for the partitioned blocks so that the coding blocks could also utilize right-side neighboring information such as reconstructed pixels and motion information, more adaptively. In an example, SUCO changes the processing order of split units from the conventional left-to-right scanning order processing to right-to-left scanning order processing. Therefore, more than two (2) sides may be available for model parameter derivation (e.g., not just left and above sides but the right side of a CB as shown in FIG. 24). The further examples shown in FIG. 25 and FIG. 26 demonstrate that the proposed process illustrated in FIG. 22 is applicable may be beneficial for partitioning frameworks like SUCO where the number of available templates may vary even for regular cases.

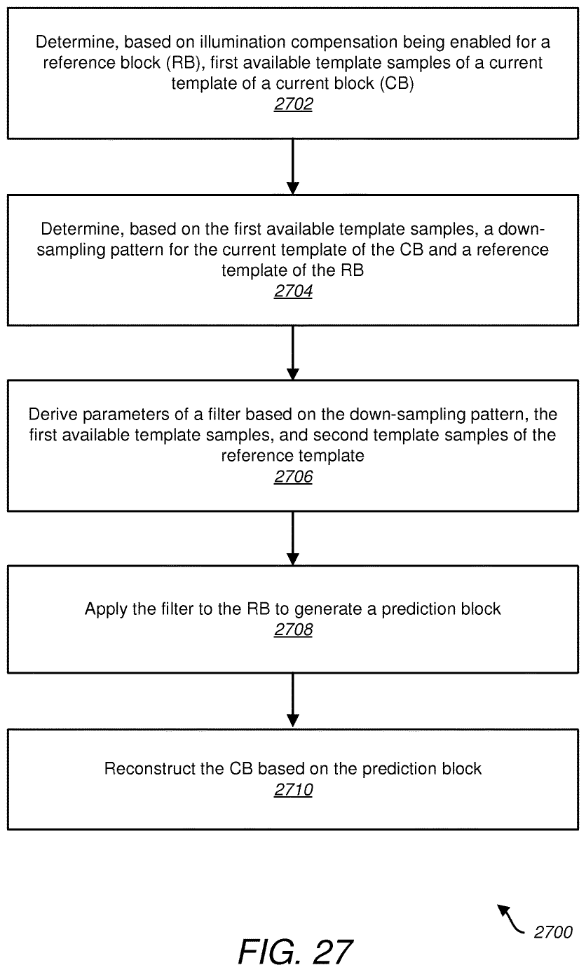

FIG. 27 shows a flowchart of a method 2700 for determining, based on first available template samples of a current block (CB), a down-sampling pattern for the current template of the CB and a reference template of a reference block (RB), and deriving parameters of a filter based on the down-sampling pattern, the first available template samples, and second template samples of the reference template, according to some embodiments. The method 2700 may be implemented by a decoder, such as decoder 300 in FIG. 3. The method 2700 begins at 2702.

At 2702, the decoder determines, based on illumination compensation being enabled for a reference block (RB), first available template samples of a current template of a current block (CB). At 2704, the decoder determines, based on the first available template samples, a down-sampling pattern for the current template of the CB and a reference template of the RB. At 2706, the decoder derives parameters of a filter based on the down-sampling pattern, the first available template samples, and second template samples of the reference template. At 2708, the decoder applies the filter to the RB to generate a prediction block. And, at 2710, the decoder reconstructs the CB based on the prediction block.

In an example, the determining, based on the first available template samples, the down-sampling pattern for the current template of the CB and the reference template of the RB may further comprise: based on determining that a first portion of the current template left of the CB is unavailable, excluding a corresponding first portion of the reference template left of the RB; or based on determining that a second portion of the current template above the CB is unavailable, excluding a corresponding second portion of the reference template above the RB. In an example, the decoder may further determine a side length of the CB based on: based on a top template being available and a left template being available, a minimum between a height and a width of the CB; based on the top template being available and the left template being unavailable, the width of the CB; and based on the left template being available and the top template being unavailable, the height of the CB.

In an example, the decoder may further determine the down-sampling pattern based on the side length. In an example, the determining the down-sampling pattern based on the side length may further comprise a length of a longer portion of a side of the CB divided by the side length. In an example, the decoder may further select, based on the down-sampling pattern, a number of samples from each available portion of the current template and each corresponding portion of the reference template. In an example, the decoder may further select a first number of samples neighboring a longer portion of a first side of the CB, and exclude a second number of samples neighboring a shorter portion of a second side of the CB.

In an example, the down-sampling pattern may comprise: sampling every available template sample; sub-sampling every other available template sample; sub-sampling every second available template sample; sub-sampling every third available template sample; or sub-sampling every fourth available template sample. In another example, the down-sampling pattern may comprise a ratio comprising a first number of available template samples to a second number of selected template samples. In another example, the down-sampling pattern may comprise an interval between selected template samples among the available template samples. In another example, the down-sampling pattern may comprise a decimation of a first number of available template samples to derive a second number of selected template samples. In an example, the determining the down-sampling pattern may further be based on determining second template samples of the reference template of the RB. In an example, the determining second template samples of the reference template of the RB may further comprise determining unavailable template samples of the RB based on padding.

In an example, the deriving the parameters of the filter may further be based on the second template samples. In an example, the deriving the parameters of the filter may further be based on second template samples of the reference template of the RB, wherein the second template samples correspond to the first available template samples. In an example, the deriving parameters of the filter based on the down-sampling pattern and the first available template samples may further comprise: deriving the parameters of the filter based on determining costs between: values of the first available template samples of the current template of the CB; and applying the filter to values of the second template samples; and determining values of the parameters of the filter corresponding to a minimum cost of the costs. In an example, the determining the costs may further be based on determining a sum of absolute differences (SAD), sum of absolute transformed differences (SATD), or sum of squared errors (SSE). In an example, a first sample, of the first available template samples, may correspond to a second sample, of the second template samples, based on the first sample and the second sample being at a same relative position with respect to the current template and the reference template, respectively.

In an example, the first available template samples of the current template of the CB may further comprise: a left portion of available samples of the current template of the CB; a top portion of available samples of the current template of the CB; or both the left portion and the top portion of available samples of the current template of the CB. In an example, the left portion of available samples of the current template may correspond to a left side of the CB. In an example, the top left portion of available samples of the current template may correspond to a top side of the CB. In another example, the current template of the CB may comprise: a plurality of columns of samples neighboring a left edge of the CB; a plurality of rows of samples neighboring a top edge of the CB; or both the plurality of columns of samples neighboring the left edge of the CB and the plurality of rows of samples neighboring the top edge of the CB.

In an example, template samples being available may comprise the template samples being within a reconstructed region. In another example, template samples being available may comprise the template samples being within a picture boundary. In an example, template samples being unavailable may comprise the template samples being outside of a reconstructed region. In another example, template samples being unavailable may comprise the template samples being outside of a picture boundary.

In an example, the second template samples of the reference template may further comprise: a left portion of available samples of the reference template of the RB; a top portion of available samples of the reference template of the RB; or both the left portion and the top portion of available samples of the reference template of the RB. In an example, the left portion of available samples of the reference template may correspond to a left side of the RB. In an example, the top left portion of available samples of the reference template may correspond to a top side of the CB. In another example, the reference template of the RB may comprise: a plurality of columns of samples neighboring a left edge of the RB; a plurality of rows of samples neighboring a top edge of the RB; or both the plurality of columns of samples neighboring the left edge of the RB and the plurality of rows of samples neighboring the top edge of the RB.

In an example, the decoder may further receive, in a bitstream, a residual associated with the CB. In an example, the reconstructing the CB based on the prediction block may further be based on the residual. In an example, the decoder may further receive, in a bitstream, a first indication indicating that illumination compensation is enabled for the RB. In an example, the decoder may further receive, in the bitstream, a second indication indicating a model for the filter.

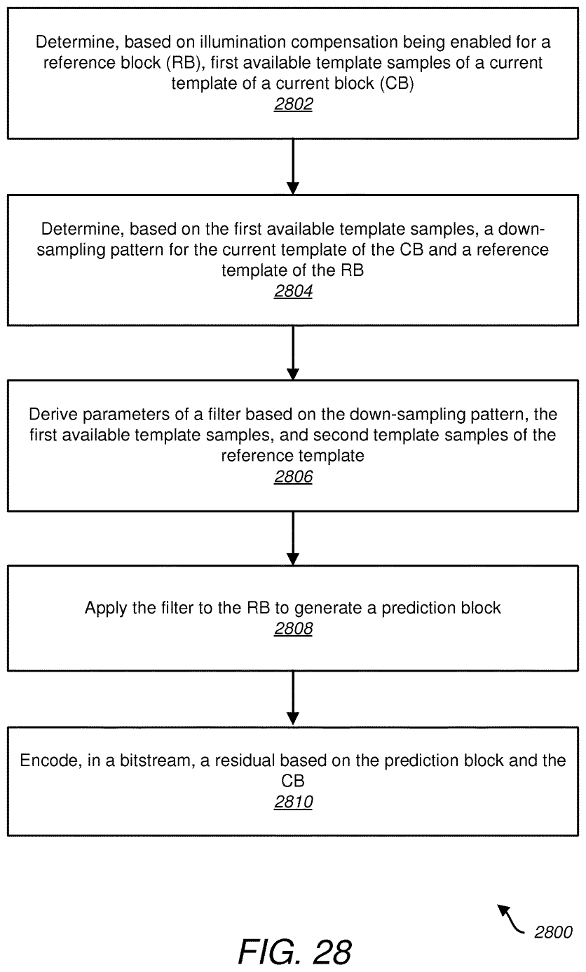

FIG. 28 shows a flowchart 2800 of a method for determining, based on first available template samples of a current block (CB), a down-sampling pattern for the current template of the CB and a reference template of a reference block (RB), and deriving parameters of a filter based on the down-sampling pattern, the first available template samples, and second template samples of the reference template, according to some embodiments. The method of flowchart 2800 may be implemented by an encoder, such as encoder 200 in FIG. 2.

At 2802, the encoder determines, based on illumination compensation being enabled for a reference block (RB), first available template samples of a current template of a current block (CB). At 2804, the encoder determines, based on the first available template samples, a down-sampling pattern for the current template of the CB and a reference template of the RB. At 2806, the encoder derives parameters of a filter based on the down-sampling pattern, the first available template samples, and second template samples of the reference template. At 2808, the encoder applies the filter to the RB to generate a prediction block. And, at 2810, the encoder encodes, in a bitstream, a residual based on the prediction block and the CB.

In an example, the determining, based on the first available template samples, the down-sampling pattern for the current template of the CB and the reference template of the RB may further comprise: based on determining that a first portion of the current template left of the CB is unavailable, excluding a corresponding first portion of the reference template left of the RB; or based on determining that a second portion of the current template above the CB is unavailable, excluding a corresponding second portion of the reference template above the RB. In an example, the encoder may further determine a side length of the CB based on: based on a top template being available and a left template being available, a minimum between a height and a width of the CB; based on the top template being available and the left template being unavailable, the width of the CB; and based on the left template being available and the top template being unavailable, the height of the CB.

In an example, the encoder may further determine the down-sampling pattern based on the side length. In an example, the determining the down-sampling pattern based on the side length may further comprise a length of a longer portion of a side of the CB divided by the side length. In an example, the encoder may further select, based on the down-sampling pattern, a number of samples from each available portion of the current template and each corresponding portion of the reference template. In an example, the encoder may further select a first number of samples neighboring a longer portion of a first side of the CB, and exclude a second number of samples neighboring a shorter portion of a second side of the CB.

In an example, the down-sampling pattern may comprise: sampling every available template sample; sub-sampling every other available template sample; sub-sampling every second available template sample; sub-sampling every third available template sample; or sub-sampling every fourth available template sample. In another example, the down-sampling pattern may comprise a ratio comprising a first number of available template samples to a second number of selected template samples. In another example, the down-sampling pattern may comprise an interval between selected template samples among the available template samples. In another example, the down-sampling pattern may comprise a decimation of a first number of available template samples to derive a second number of selected template samples. In an example, the determining the down-sampling pattern may further be based on determining second template samples of the reference template of the RB. In an example, the determining second template samples of the reference template of the RB may further comprise determining unavailable template samples of the RB based on padding.

In an example, the deriving the parameters of the filter may further be based on the second template samples. In an example, the deriving the parameters of the filter may further be based on second template samples of the reference template of the RB, wherein the second template samples correspond to the first available template samples. In an example, the deriving parameters of the filter based on the down-sampling pattern and the first available template samples may further comprise: deriving the parameters of the filter based on determining costs between: values of the first available template samples of the current template of the CB; and applying the filter to values of the second template samples; and determining values of the parameters of the filter corresponding to a minimum cost of the costs. In an example, the determining the costs may further be based on determining a sum of absolute differences (SAD), sum of absolute transformed differences (SATD), or sum of squared errors (SSE). In an example, a first sample, of the first available template samples, may correspond to a second sample, of the second template samples, based on the first sample and the second sample being at a same relative position with respect to the current template and the reference template, respectively.

In an example, the first available template samples of the current template of the CB may further comprise: a left portion of available samples of the current template of the CB; a top portion of available samples of the current template of the CB; or both the left portion and the top portion of available samples of the current template of the CB. In an example, the left portion of available samples of the current template may correspond to a left side of the CB. In an example, the top left portion of available samples of the current template may correspond to a top side of the CB. In another example, the current template of the CB may comprise: a plurality of columns of samples neighboring a left edge of the CB; a plurality of rows of samples neighboring a top edge of the CB; or both the plurality of columns of samples neighboring the left edge of the CB and the plurality of rows of samples neighboring the top edge of the CB.

In an example, template samples being available may comprise the template samples being within a reconstructed region. In another example, template samples being available may comprise the template samples being within a picture boundary. In an example, template samples being unavailable may comprise the template samples being outside of a reconstructed region. In another example, template samples being unavailable may comprise the template samples being outside of a picture boundary.

In an example, the second template samples of the reference template may further comprise: a left portion of available samples of the reference template of the RB; a top portion of available samples of the reference template of the RB; or both the left portion and the top portion of available samples of the reference template of the RB. In an example, the left portion of available samples of the reference template may correspond to a left side of the RB. In an example, the top left portion of available samples of the reference template may correspond to a top side of the CB. In another example, the reference template of the RB may comprise: a plurality of columns of samples neighboring a left edge of the RB; a plurality of rows of samples neighboring a top edge of the RB; or both the plurality of columns of samples neighboring the left edge of the RB and the plurality of rows of samples neighboring the top edge of the RB.

In an example, the encoder may further encode, in the bitstream, a first indication indicating that illumination compensation is enabled for the RB. In an example, the encoder may further encode, in the bitstream, a second indication indicating a model for the filter.

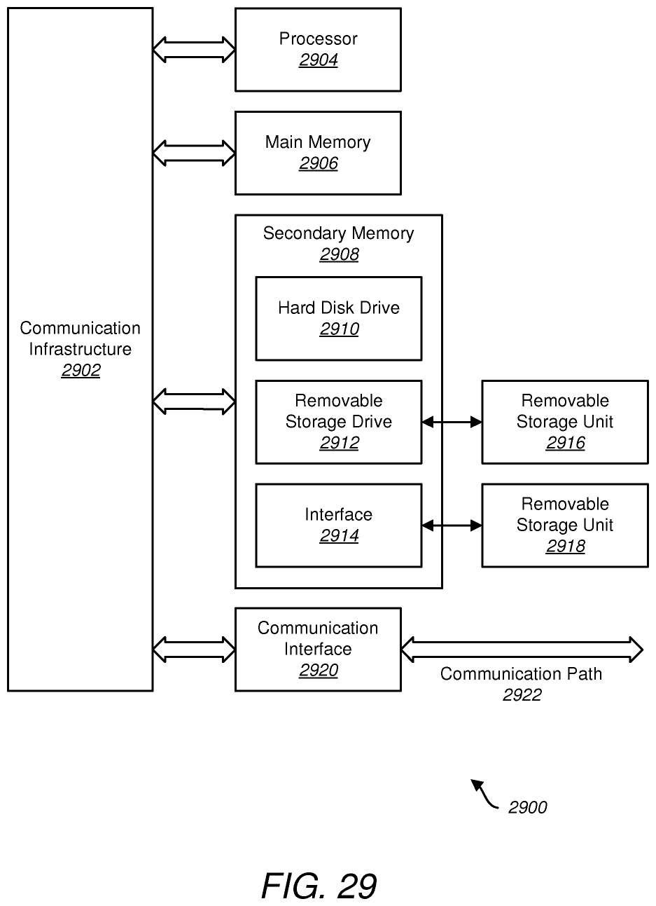

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 2900 is shown in FIG. 29. Blocks depicted in the figures above, such as the blocks in FIGS. 1, 2, and 3, may execute on one or more computer systems 2900. Furthermore, each of the steps of the flowcharts depicted in this disclosure may be implemented on one or more computer systems 2900.

Computer system 2900 includes one or more processors, such as processor 2904. Processor 2904 may be, for example, a special purpose processor, general purpose processor, microprocessor, or digital signal processor. Processor 2904 may be connected to a communication infrastructure 2902 (for example, a bus or network). Computer system 2900 may also include a main memory 2906, such as random access memory (RAM), and may also include a secondary memory 2908.

Secondary memory 2908 may include, for example, a hard disk drive 2910 and/or a removable storage drive 2912, representing a magnetic tape drive, an optical disk drive, or the like. Removable storage drive 2912 may read from and/or write to a removable storage unit 2916 in a well-known manner. Removable storage unit 2916 represents a magnetic tape, optical disk, or the like, which is read by and written to by removable storage drive 2912. As will be appreciated by persons skilled in the relevant art(s), removable storage unit 2916 includes a computer usable storage medium having stored therein computer software and/or data.

In alternative implementations, secondary memory 2908 may include other similar means for allowing computer programs or other instructions to be loaded into computer system 2900. Such means may include, for example, a removable storage unit 2918 and an interface 2914. Examples of such means may include a program cartridge and cartridge interface (such as that found in video game devices), a removable memory chip (such as an EPROM or PROM) and associated socket, a thumb drive and USB port, and other removable storage units 2918 and interfaces 2914 which allow software and data to be transferred from removable storage unit 2918 to computer system 2900.

Computer system 2900 may also include a communications interface 2920. Communications interface 2920 allows software and data to be transferred between computer system 2900 and external devices. Examples of communications interface 2920 may include a modem, a network interface (such as an Ethernet card), a communications port, etc. Software and data transferred via communications interface 2920 are in the form of signals which may be electronic, electromagnetic, optical, or other signals capable of being received by communications interface 2920. These signals are provided to communications interface 2920 via a communications path 2922. Communications path 2922 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 2916 and 2918 or a hard disk installed in hard disk drive 2910. These computer program products are means for providing software to computer system 2900. Computer programs (also called computer control logic) may be stored in main memory 2906 and/or secondary memory 2908. Computer programs may also be received via communications interface 2920. Such computer programs, when executed, enable the computer system 2900 to implement the present disclosure as discussed herein. In particular, the computer programs, when executed, enable processor 2904 to implement the processes of the present disclosure, such as any of the methods described herein. Accordingly, such computer programs represent controllers of the computer system 2900.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
determining, based on illumination compensation being enabled for a reference block (RB), whether:
a first portion of a current template of a current block (CB) is available, wherein the first portion comprises samples of the current template left of the CB; and
a second portion of the current template is available, wherein the second portion comprises template samples of the current template above the CB;
determining, based on the determining of whether the first and second portions are available, a sampling pattern for the current template of the CB and for a reference template of the RB;
deriving values of parameters of a filter based on the sampling pattern, available template samples of at least one of the first and second portions, and reference template samples of the reference template;
applying the filter to the RB to generate a prediction block; and
decoding the CB based on the prediction block.

2. The method of claim 1, wherein the determining the sampling pattern comprises:
determining a side length of the CB based on the determining of whether the first and second portions are available; and
determining, based on the side length, a sampling interval of the sampling pattern.

3. The method of claim 2, wherein the side length is determined as:
a minimum of a height and a width of the CB, based on the determination of the first and second portions both being available;
the width of the CB based on the determination of the second portion being available and the first portion being unavailable; and
the height of the CB based on the determination of the first portion being available and the second portion being unavailable.

4. The method of claim 1, wherein the sampling pattern comprises:
a first sampling pattern comprising sampling every available template sample, based on only one of the first and second portions being available; and
a second sampling pattern based on both the first and second portions being available.

5. The method of claim 1, wherein the determining the sampling pattern is further based on determining whether:
a first reference portion of the reference template is available, wherein the first reference portion comprises samples of the reference template left of the RB; and
a second reference portion of the reference template is available, wherein the second reference portion comprises template samples of the reference template above the RB.

6. The method of claim 1, further comprising:
obtaining, from a bitstream, a first indication indicating that the illumination compensation is enabled for the RB, wherein the determining whether the first and second portions are available is based on the first indication.

7. The method of claim 6, further comprising:
obtaining, from the bitstream, a second indication indicating a model for the filter, wherein the model specifies the parameters of the filter.

8. A decoder comprising:
one or more processors; and
memory storing instructions that, when executed by the one or more processors, cause the decoder to:
determine, based on illumination compensation being enabled for a reference block (RB), whether:
a first portion of a current template of a current block (CB) is available, wherein the first portion comprises samples of the current template left of the CB; and
a second portion of the current template is available, wherein the second portion comprises template samples of the current template above the CB;
determine, based on the determining of whether the first and second portions are available, a sampling pattern for the current template of the CB and for a reference template of the RB;
derive values of parameters of a filter based on the sampling pattern, available template samples of at least one of the first and second portions, and reference template samples of the reference template;
apply the filter to the RB to generate a prediction block; and
decode the CB based on the prediction block.

9. The decoder of claim 8, wherein to determine the sampling pattern, the instructions further cause the decoder to:
determine a side length of the CB based on the determining of whether the first and second portions are available; and
determine, based on the side length, a sampling interval of the sampling pattern.

10. The decoder of claim 9, wherein the side length is determined as:
a minimum of a height and a width of the CB, based on the determination of the first and second portions both being available;
the width of the CB based on the determination of the second portion being available and the first portion being unavailable; and
the height of the CB based on the determination of the first portion being available and the second portion being unavailable.

11. The decoder of claim 8, wherein the sampling pattern comprises:
a first sampling pattern comprising sampling every available template sample, based on only one of the first and second portions being available; and
a second sampling pattern based on both the first and second portions being available.

12. The decoder of claim 8, wherein, to determine the sampling pattern, the instructions further cause the decoder to determine whether:
a first reference portion of the reference template is available, wherein the first reference portion comprises samples of the reference template left of the RB; and
a second reference portion of the reference template is available, wherein the second reference portion comprises template samples of the reference template above the RB.

13. The decoder of claim 8, the instructions further cause the decoder to:
obtain, from a bitstream, a first indication indicating that the illumination compensation is enabled for the RB, wherein the determining whether the first and second portions are available is based on the first indication.

14. The decoder of claim 13, wherein the instructions further cause the decoder to:
obtaining, from the bitstream, a second indication indicating a model for the filter, wherein the model specifies the parameters of the filter.

15. A non-transitory computer-readable medium comprising instructions that, when executed by one or more processors of a decoder, cause the decoder to:
determine, based on illumination compensation being enabled for a reference block (RB), whether:
a first portion of a current template of a current block (CB) is available, wherein the first portion comprises samples of the current template left of the CB; and
a second portion of the current template is available, wherein the second portion comprises template samples of the current template above the CB;
determine, based on the determining of whether the first and second portions are available, a sampling pattern for the current template of the CB and for a reference template of the RB;
derive values of parameters of a filter based on the sampling pattern, available template samples of at least one of the first and second portions, and reference template samples of the reference template;
apply the filter to the RB to generate a prediction block; and
decode the CB based on the prediction block.

16. The non-transitory computer-readable medium of claim 15, wherein to determine the sampling pattern, the instructions further cause the decoder to:
determine a side length of the CB based on the determining of whether the first and second portions are available; and
determine, based on the side length, a sampling interval of the sampling pattern.

17. The non-transitory computer-readable medium of claim 16, wherein the side length is determined as:
a minimum of a height and a width of the CB, based on the determination of the first and second portions both being available;
the width of the CB based on the determination of the second portion being available and the first portion being unavailable; and
the height of the CB based on the determination of the first portion being available and the second portion being unavailable.

18. The non-transitory computer-readable medium of claim 15, wherein, to determine the sampling pattern, the instructions further cause the decoder to determine whether:
a first reference portion of the reference template is available, wherein the first reference portion comprises samples of the reference template left of the RB; and
a second reference portion of the reference template is available, wherein the second reference portion comprises template samples of the reference template above the RB.

19. The non-transitory computer-readable medium of claim 15, the instructions further cause the decoder to:
obtain, from a bitstream, a first indication indicating that the illumination compensation is enabled for the RB, wherein the determining whether the first and second portions are available is based on the first indication.

20. The non-transitory computer-readable medium of claim 19, wherein the instructions further cause the decoder to:
obtaining, from the bitstream, a second indication indicating a model for the filter, wherein the model specifies the parameters of the filter.
